(19) United States
(12) Patent Application Publication
(10) Pub. No.: US 2015/0198902 A1
(43) Pub. Date: Jul. 16, 2015

(54) STATIC CHARGE IMAGE DEVELOPING TONER AND IMAGE FORMING METHOD, IMAGE FORMING APPARATUS, AND PROCESS CARTRIDGE USING SAME

(71) Applicants: Shun Saito, Shizuoka (JP); Osamu Uchinokura, Shizuoka (JP); Satoshi Ogawa, Nara (JP); Satoshi Kojima, Shizuoka (JP); Rintaro Takahashi, Kanagawa (JP)

(72) Inventors: Shun Saito, Shizuoka (JP); Osamu Uchinokura, Shizuoka (JP); Satoshi Ogawa, Nara (JP); Satoshi Kojima, Shizuoka (JP); Rintaro Takahashi, Kanagawa (JP)

(21) Appl. No.: 14/587,086

(22) Filed: Dec. 31, 2014

(30) Foreign Application Priority Data
Jan. 16, 2014 (JP) 2014-005881

(51) Int. Cl. G03G 9/00

(52) U.S. Cl. CPC G03G 9/08755; G03G 9/0821

(57) ABSTRACT

Provided is a static charge image developing toner of which flowing start temperatures (Tfb) measured with a flow tester satisfy relational formulae below:

Tfb(2-5)=100−[Tfb(5 Kg)/Tfb(2 Kg)]×100 (Formula 1)

2.00≦Tfb(2-5)≦6.50 (Formula 2)
where in Formula 1 above, Tfb(2 Kg) and Tfb(5 Kg) represent flowing start temperatures of the static charge image developing toner when 1.5 g of the toner is heated at a temperature raising rate of 3° C./minute and let to flow out from a die having a diameter of 1.0 mm under loads of 2 Kg and 5 Kg respectively.

### BACKGROUND OF THE INVENTION

1. Field of the Invention

The present invention relates to a static charge image developing toner used in image forming technologies utilizing an electrophotography process, and an image forming method, an image forming apparatus, and a process cartridge using the same.

2. Description of the Related Art

Image formation by electrophotography is commonly performed through a series of processes of forming a static charge image on a photoconductor (static charge image bearer), developing the static charge image with a toner to form a visible image (toner image), transferring the toner image onto a recording medium such as a sheet, and fixing it thereon to form a fixed image. In recent years, there have been demands that toners used in such image forming processes should have a smaller particle size for improving the quality of the images, and should have low temperature fixability for saving energy.

In order to improve low temperature fixability, use of a resin and a wax having a low softening temperature as binder resins, combined use of a crystalline resin, and various such measures have been thought up and various methods have been proposed. However, there is a limit to catering to the demands by simply making a resin and a wax softenable at a low temperature. In production of a toner, it is necessary to satisfy not only the demand for low temperature fixability, but also various properties such as heat resistant storage stability, offset resistance, high image quality, reproducibility, etc. at the same time. That is, it is demanded that heat resistant storage stability and hot offset resistance of a toner be not inhibited along with improvement in the low temperature fixability thereof. In order to aim for a greater degree of low temperature fixability, it is necessary to control the thermal properties of a resin itself, and to deal with this subject, attempts have been made to use as a binder resin of a toner, not only a styrene-acrylic resin, which has often been used conventionally, but also polyester having excellent low temperature fixability and relatively favorable heat resistant storage stability.

For example, there is proposed a toner having low temperature fixability, heat resistant storage stability, and a high spreadability, which is obtained by controlling a softening temperature (RT) of a non-crystalline resin and a softening temperature (CT) of a crystalline resin and prescribing the relationship between RT and CT (see, e.g., Japanese Patent Application Laid-Open (JP-A) No. 2012-247657).

Because there is a general trend among toners having excellent low temperature fixability that they are likely to incur a blocking phenomenon of being concreted by heat generated by an apparatus used, heat during storage, etc., there is known a method of controlling the softening temperatures of a core portion and a shell layer of a toner having a core-shell structure.

To ensure a toner a low temperature fixability, toner spreadability is important in addition to thermal properties thereof. Toner spreadability indicates to what degree the toner itself has been heated when it starts to fluidize. This parameter is typically expressed by by what degree a frontal projected area of a toner changes when the toner is heated (by what degree a frontal projected area of a toner has changed at a flowing start temperature of the toner). However, the change in the frontal projected area is dependent on each individual toner and very significantly varies from toner to toner. Hence, there is no established method for evaluation of toner spreadability.

In any case, it is necessary to accurately figure out spreadability of a toner in addition to thermal properties (glass transition temperature, softening temperature, etc.) thereof. The current state of the art is not satisfactory in realizing both of a sufficient low temperature fixability and a high heat resistant storage stability at the same time.

### SUMMARY OF THE INVENTION

As described in, e.g., JP-A No. 2012-247657, conventional techniques control a non-crystalline resin and a crystalline resin used as binder resins such that the relationship between the softening temperature (RT) of the non-crystalline resin and the softening temperature (CT) of the crystalline resin may be 5≦RT−CT≦20, which the publication says that realizes low temperature fixability and heat resistant storage stability at the same time and ensures a high spreadability. Here, the demanded goals are achieved by suppressing the molecular weight of the binder resins and removing a protective colloid-derived resin (organic particles) on the surface of the toner with an alkaline component. These methods can surely achieve a high spreadability, but they have a problem of degrading the heat resistant storage stability instead.

As described above, the factors that determine the fixability of a toner include thermal properties of the toner (softening temperature, glass transition temperature, etc.). As a method for evaluating the thermal properties, there is known a method of imposing a load on a toner sample with a flow tester. Since the measurement of flowability of the toner with the flow tester is performed under a load, the obtained result is a bulk evaluation.

On the other hand, low temperature fixability of a toner is influenced not only by the thermal properties of the toner but also by spreadability thereof. Toner spreadability indicates to what degree a toner itself has been heated when it starts to fluidize, and is typically expressed by by what degree a frontal projected area of the toner changes when the toner is heated. The change in the frontal projected area can be observed directly. However, because the change in the frontal projected area of a toner has a large individual difference and significantly varies from toner to toner, there is no established method for evaluation of toner spreadability.

This is apparent from the fact that a toner having a core-shell structure, in which the external portion is hard and the internal portion is soft, has a poor spreadability because the external shell is hard, but the spreadability nevertheless is evaluated as substantially an equal value to that of a toner having no core-shell structure because the toner is let to flow out under a load in a flow tester evaluation. Hence, it has been impossible to distinguish or discriminate the accurate effect of the spreadability on the low temperature fixability.

The present invention was made in view of the conventional techniques described above, and an object of the present invention is to provide a static charge image developing toner that has an excellent spreadability and satisfies low temperature fixability and heat resistant storage stability at the same time.

As a result of studies for a method for measuring a thermal behavior of a toner with a flow tester, the present inventors have found it possible to evaluate spreadability of a toner by measuring a flowing start temperature (Tfb) of a toner sample under a load that is suppressed to the lowest possible level, then measuring a flowing start temperature (Tfb) of the toner at a load that is slightly increased from the lowest possible level, and calculating the ratio of change between these flowing start temperatures. The present inventors have also found it possible to realize an excellent spreadability and satisfy low temperature fixability and heat resistant storage stability at the same time when the ratio of change is within a specific range.

That is, the problems described above are solved by a static charge image developing toner of which flowing start temperatures (Tfb) measured with a flow tester satisfy a relational formula below.

Tfb(2-5)=100−[Tfb(5 Kg)/Tfb(2 Kg)]×100 (Formula 1)

2.00≦Tfb(2-5)≦6.50 (Formula 2)

(In Formula 1, Tfb(2 Kg) and Tfb(5 Kg) represent flowing start temperatures of the static charge image developing toner when 1.5 g of the toner is heated at a temperature raising rate of 3° C./minute and let to flow out from a die having a diameter of 1.0 mm under loads of 2 Kg and 5 Kg respectively.)

The present invention can provide a static charge image developing toner that has an excellent spreadability and satisfies low temperature fixability and heat resistant storage stability at the same time.

### BRIEF DESCRIPTION OF THE DRAWINGS

FIG. 1 is an exemplary diagram for obtaining a flowing start temperature Tfb with a flow tester.

FIG. 2 is a schematic diagram showing an example of a configuration of an image forming apparatus according to an embodiment of the present invention.

FIG. 3 is a main portion schematic diagram showing an example of a configuration of an image forming unit (2) in which a photoconductor of FIG. 2 is disposed.

FIG. 4 is a schematic diagram showing an example of a configuration of a developing device (5) of FIG. 3.

FIG. 5 is a schematic diagram showing an example of a configuration of a process cartridge according to an embodiment of the present invention.

### DETAILED DESCRIPTION OF THE INVENTION

As described above, a static charge image developing toner of the present invention is characterized in that its flowing start temperatures (Tfb) measured with a flow tester satisfy the relational formula below.

Tfb(2-5)=100−[Tfb(5 Kg)/Tfb(2 Kg)]×100 (Formula 1)

2.00≦Tfb(2-5)≦6.50 (Formula 2)

(In Formula 1, Tfb(2 Kg) and Tfb(5 Kg) represent flowing start temperatures of the static charge image developing toner when 1.5 g of the toner is heated at a temperature raising rate of 3° C./minute and let to flow out from a die having a diameter of 1.0 mm under loads of 2 Kg and 5 Kg respectively.)

The “static charge image developing toner” may hereinafter be abbreviated as “toner”.

As a result of studies for a method for measuring a thermal behavior of a toner with a flow tester, the present inventors have found it possible to evaluate spreadability of a toner by measuring a flowing start temperature (Tfb) of a toner sample under a load that is suppressed to the lowest possible level, then measuring a flowing start temperature (Tfb) of the toner at a load that is slightly increased from the lowest possible level, and calculating the ratio of change between these flowing start temperatures. The present inventors have also found it possible to realize an excellent spreadability and satisfy low temperature fixability and heat resistant storage stability at the same time when the ratio of change is within a specific range.

The meaning of calculating the ratio of change is the capability of accurate evaluation of the stretchability (spreadability) of a toner, as long as how it is easy for the toner to flow out does not vary between when it is measured under a load suppressed to the lowest possible level and when it is measured under a load slightly increased from that level, i.e., as long as how it is easy for the toner to spread is independent of the load and does not vary due to whether there is a slight load or no load. That is, it is possible to grasp a behavior of flowing of toner particles with their own weight. With only one measurement load, it is impossible to evaluate the spreadability of a toner because the spreadability cannot avoid dependency on the thermal properties of the toner (bulk).

The present inventors have tested two loads, and found that when the measurement load that is at the lowest possible level is 2 Kg, it is less likely for troubles, such as clogging of a die to be filled with toner samples, to occur during the measurement, and that when the load difference is 3 Kg, i.e., with a load of 5 Kg, the ratio of change can be measured without variation.

Flowing start temperatures (Tfb) of a toner measured with a flow tester in the present invention will be explained. A flow tester (CFT-500) manufactured by Shimadzu Corporation is used as a measurement instrument. The measurement instrument is not limited to this, as long as any other instrument to be used instead can perform an evaluation equivalent to that of this instrument.

As a measurement sample, a toner (1.5 g) is weighed out and filled in a die having a diameter (φ) of 1.0 mm, and a height (H) of 1.0 mm. As the sample heating conditions, a temperature raising rate is 3.0° C./min, a preheating time is 180 seconds, and the measurement temperature range is from 80° C. to 140° C. Under these heating conditions, loads of 5 Kg and 2 Kg are imposed on the measurement sample, and measurement is performed under each of the two load conditions, to thereby obtain flowing start temperatures Tfb(5 Kg) and Tfb(2 Kg). The obtained values Tfb(5 Kg) and Tfb(2 Kg) are substituted in Formula 1 below to calculate Tfb(2-5).

Tfb(2-5)=100−[Tfb(5 Kg)/Tfb(2 Kg)]×100 (Formula 1)

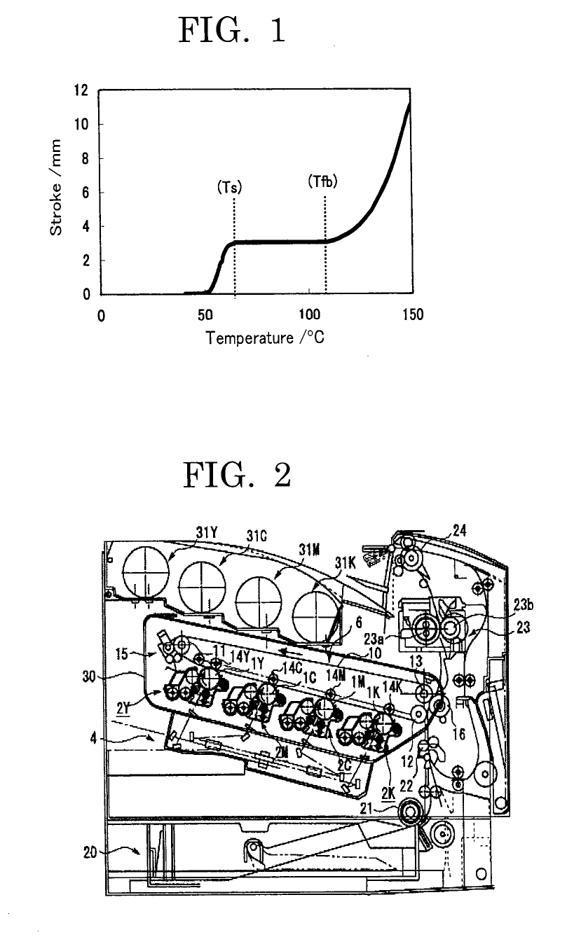

Here, as shown in the exemplary diagram of FIG. 1, a flowing start temperature Tfb can be obtained from a flow curve (heating temperature vs. piston stroke) measured with the flow tester. In the flow curve of FIG. 1, Ts represents a softening temperature, and Tfb represents a flowing start temperature.

A lower value of Tfb(2-5) represented by (Formula 1) above indicates a higher self-spreadability of a toner, which means that even when the load (pressure) is close to zero, the toner fluidizes with its own weight at around a temperature at which it melts, and the toner particles stretch and spread. A greater spreading of the toner means a greater degree of low temperature fixability of the toner.

It is not preferable that Tfb(2-5) be less than 2.00, because heat resistant storage stability is extremely poor. It is also not preferable that Tfb(2-5) be greater than 6.50, because the toner may be partially fixed in failure. Tfb(2-5) is preferably from 2.00 to 6.50, and more preferably from 2.50 to 3.20.

The toner of the present invention contains at least a binder resin as its indispensable constituent component. The toner may also contain a release agent for improving releasability, and may further contain an external additive, a deforming agent, and a charge controlling agent for aiding in flowability, developability, and chargeability, according to necessity. Furthermore, the toner may contain a colorant according to necessity, in order to produce an arbitrary color after fixed.

The binder resin as a constituent component among the materials of the toner of the present invention is not particularly limited. Examples thereof include various resins such as a styrene/acrylic polymer (e.g., a styrene/n-butyl acrylate copolymer), and polyester.

In the present invention, the following points about the resin to constitute the toner are taken account of as requirements for satisfying Formula 2, in order to provide a toner that has an excellent spreadability and satisfies low temperature fixability and heat resistant storage stability at the same time.

That is, the points taken account of are that “the thermal properties of the binder resin should be suppressed to some degree”, but “on the condition the toner should partially contain polyester having high thermal properties”, and that “organic resin particles having relatively high thermal properties should be present in the surface of the toner”.

As described in Examples given below, as a result of studying compositions with various binder resins, it was confirmed that Formula 2 was satisfied by formulating a binder resin composition by mixing a binder resin of which thermal properties are suppressed to some degree appropriately with polyester having high thermal properties, and by making organic resin particles present in a surface of the toner.

For example, a binder resin mainly composed of a styrene/acrylic copolymer (e.g., styrene/n-butyl acrylate copolymer) of which thermal properties are suppressed to some degree can realize a toner that has thermal properties lower than conventional, but nevertheless has an excellent spreadability and satisfies low temperature fixability and heat resistant storage stability at the same time, provided that the binder resin contains polyester having high thermal properties (e.g., isocyanate-modified polyester), and is controlled such that organic resin particles (e.g., a copolymer of styrene/methacrylic acid/butyl acrylate/methacrylic acid ethylene oxide adduct sulfate sodium salt) used as a protective colloid agent when an oil phase of the binder resin in an organic solvent is dispersed and granulated in an aqueous medium may remain in the surface of the toner.

Further, a binder resin mainly composed of polyester can realize a toner that has thermal properties lower than conventional, but nevertheless has an excellent spreadability and satisfies low temperature fixability and heat resistant storage stability at the same time, provided that the binder resin contains a large amount of adipic acid, which is a paraffin component, as an acid component of polyester to have thermal properties thereof suppressed, and meanwhile contains polyester having high thermal properties (e.g., isocyanate-modified polyester), and is controlled such that organic resin particles (e.g., a copolymer of styrene/methacrylic acid/butyl acrylate/methacrylic acid ethylene oxide adduct sulfate sodium salt) used as a protective colloid agent when an oil phase of the binder resin in an organic solvent is dispersed and granulated in an aqueous medium may remain in the surface of the toner.

As described above, the toner of the present invention needs to contain a binder resin as an indispensable constituent component, and may contain a colorant, a release agent, an external additive, and a charge controlling agent according to necessity.

### (Binder Resin)

The binder resin is not particularly limited, and examples thereof include polyester, polyurethane, polyurea, an epoxy resin, a vinyl resin (e.g., a styrene/acrylic copolymer, a styrene resin, and an acrylic resin), and a hybrid resin in which different kinds of resins are chemically bonded. Reactive functional groups may be incorporated at a terminal or a side chain of the resin, so that they may be bound with each other in the production process of the toner to thereby elongate the toner. One of the binder resins given above may be used alone, or a plurality of these may be used as a mixture.

The binder resin as a constituent component of the toner of the present invention may be an unmodified binder resin (e.g., unmodified polyester), a crystalline resin (e.g., crystalline polyester), and a modified resin (e.g., isocyanate-modified polyester). These may be used as an appropriate mixture.

In the present invention, a composition satisfying Formula 2 above is determined based on selection of binder resin components from among various resins. Preferable examples of such resins include a styrene/acrylic copolymer, polyester, and isocyanate-modified polyester.

A binder resin to constitute the main part of the toner should be a resin that at least partially dissolves in an organic medium. The acid value of such a binder resin is preferably from 2 mgKOH/g to 24 mgKOH/g. When the acid value is 24 mgKOH/g or less, it becomes harder for the binder resin to transition to an aqueous phase, which makes it less likely for mass balance loss to occur in the production process, or makes it less likely for troubles such as degradation of dispersion stability of oil droplets to occur in the production process. Furthermore, this suppresses water adsorption of the toner to suppress degradation of chargeability, and also suppresses degradation of storage stability under high-temperature, high-humidity conditions. When the acid value is 2 mgKOH/g or greater, the resin has a high polarity, which makes it possible for a colorant having some polarity to be dispersed uniformly in an oil droplet.

As described above, the kind of the binder resin is not particularly limited. However, a resin having a polyester skeleton is preferable for a static charge image developing toner for electrophotography, because such a resin makes it possible to obtain a favorable fixability. Examples of resins having a polyester skeleton include polyester, and a block polymer of polyester with a resin having any other skeleton. Polyester is more preferable because uniformity of toner particles to be obtained will be greater.

### <Unmodified Polyester>

Examples of polyester include products obtained by ring-opening-polymerizing lactones, a product obtained by condensation-polymerizing a hydroxycarboxylic acid, and a product obtained by polycondensing a polyol and a polycarboxylic acid. A product obtained by polycondensing a polyol and a polycarboxylic acid is preferable in terms of latitude allowed in designing.

A peak molecular weight of the polyester is typically from 1,000 to 30,000, preferably from 1,500 to 10,000, and more preferably from 2,000 to 8,000. When the peak molecular weight is greater 1,000 or greater, a favorable heat resistant storage stability is obtained. When the peak molecular weight is 30,000 or less, a low temperature fixability that is favorable as a property of a static charge image developing toner is obtained.

A glass transition temperature of the polyester is from 45° C. to 70° C., and preferably from 50° C. to 65° C. When a main portion is covered with a convex as in the present invention, the resin in the convex may be plasticized by moisture in the atmosphere during storage under high-temperature, high-humidity conditions, which may lower the glass transition temperature. High-temperature, high-humidity conditions of 40° C. and 90% are assumed during shipping of the toner or a toner cartridge, and under such conditions, particles of the produced toner may deform or may adhere to each other when they are placed under a certain pressure and may not be able to behave as they are originally expected to behave as particles. Therefore, the glass transition temperature is preferably 45° C. or higher. When the glass transition temperature is 70° C. or lower, a good low temperature fixability is obtained, which is favorable.

Examples of the polyester used in the present invention include a product obtained by reacting one kind or two or more kinds of polyols with one kind or two or more kinds of polycarboxylic acids with each other. Examples of the polyols and polycarboxylic acids are given below.

### <Polyol>

Examples of a polyol (1) include a diol (1-1), and a trivalent or higher polyol (1-2). (1-1) alone, or a mixture of (1-1) with a small amount of (1-2) is preferable.

Examples of the diol (1-1) include: alkylene glycol (e.g., ethylene glycol, 1,2-propylene glycol, 1,3-propylene glycol, 1,4-butanediol, and 1,6-hexanediol); alkylene ether glycol (e.g., diethylene glycol, triethylene glycol, dipropylene glycol, polyethylene glycol, polypropylene glycol, and polytetramethylene ether glycol); alicyclic diol (e.g., 1,4-cyclohexanedimethanol, and hydrogenated bisphenol A); bisphenols (e.g., bisphenol A, bisphenol F, and bisphenol S); alkylene oxide (e.g., ethylene oxide, propylene oxide, and butylene oxide) adduct of the alicyclic diol; 4,4′-dihydroxybiphenyl, such as 3,3′-difluoro-4,4′-dihydroxybiphenyl; bis(hydroxyphenyl)alkane, such as bis(3-fluoro-4-hydroxyphenyl)methane, 1-phenyl-1,1-bis(3-fluoro-4-hydroxyphenyl)ethane, 2,2-bis(3-fluoro-4-hydroxyphenyl)propane, 2,2-bis(3,5-difluoro-4-hydroxyphenyl)propane (also known as tetrafluorobisphenol A), and 2,2-bis(3-hydroxyphenyl)-1,1,1,3,3,3-hexafluoropropane; bis(4-hydroxyphenyl)ether, such as bis(3-fluoro-4-hydroxyphenyl)ether; and alkylene oxide (e.g., ethylene oxide, propylene oxide, and butylene oxide) adduct of the bisphenols.

Among these, alkylene oxide adducts of alkylene glycol having 2 to 12 carbon atoms, and alkylene oxide adducts of bisphenols are preferable, and alkylene oxide adducts of bisphenols, and combinations thereof with alkylene glycol having 2 to 12 carbon atoms are particularly preferable.

Examples of the trivalent or higher polyol (1-2) include: 3 to 8 or higher multivalent aliphatic alcohols (e.g., glycerin, trimethylolethane, trimethylolpropane, pentaerythritol, and sorbitol); trivalent or higher phenols (e.g., trisphenol PA, phenol novolac, and cresol novolac); and alkylene oxide adduct of the trivalent or higher polyphenols.

### <Polycarboxylic Acid>

Examples of a polycarboxylic acid (2) include a dicarboxylic acid (2-1), and a trivalent or higher polycarboxylic acid (2-2). (2-1) alone, or a mixture of (2-1) with a small amount of (2-2) is preferable.

Examples of the dicarboxylic acid (2-1) include; alkylene dicarboxylic acid (e.g., succinic acid, adipic acid, and sebacic acid); alkenylene dicarboxylic acid (e.g., maleic acid, and fumaric acid); aromatic dicarboxylic acid (e.g., phthalic acid, isophthalic acid, terephthalic acid, and naphthalene dicarboxylic acid); and 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethyl isophthalic acid, 2,2-bis(4-carboxyphenyl)hexafluoropropane, 2,2-bis(3-carboxyphenyl)hexafluoropropane, 2,2′-bis(trifluoromethyl)-4,4′-biphenyl dicarboxylic acid, 3,3′-bis(trifluoromethyl)-4,4′-biphenyl dicarboxylic acid, 2,2′-bis(trifluoromethyl)-3,3′-biphenyl dicarboxylic acid, and hexafluoroisopropylidene diphthalic anhydride. Among these, alkenylene dicarboxylic acid having 4 to 20 carbon atoms, and aromatic dicarboxylic acid having 8 to 20 carbon atoms are preferable.

Particularly, it is preferable that a structural unit that is derived from an acid component and has a molecular skeleton of polyester be a structural unit that is derived from an aromatic dicarboxylic acid compound and has a carboxylic acid group at a meth- or para-position of a benzene ring. That is, it is preferable that a structural unit derived from an acid component be a structural unit that is derived from an aromatic dicarboxylic acid compound and has a carboxylic acid group at a 1,4-position, or 2,5-position, or a 3,6-position of a benzene ring.

Examples of the trivalent or higher polycarboxylic acid (2-2) include aromatic polycarboxylic acid having 9 to 20 carbon atoms (e.g., trimellitic acid, and pyromellitic acid).

Note that as the polycarboxylic acid (2), an acid anhydride or a lower alkyl ester (e.g., methyl ester, ethyl ester, and isopropyl ester) of those described above may be reacted with the polyol (1).

The ratio between the polyol and the polycarboxylic acid is typically from 2/1 to 1/2, preferably from 1.5/1 to 1/1.5, and more preferably from 1.3/1 to 1/1.3, when expressed as an equivalent ratio [OH]/[COOH] of hydroxyl group [OH] to carboxyl group [COOH].

Examples of unmodified polyester include a product obtained by blocking an active hydrogen group (e.g., a hydroxyl group at a terminal) of polyester with a blocking agent (e.g., a monovalent compound such as ethyl isocyanate and phenyl isocyanate).

### <Crystalline Polyester>

The binder resin may contain a crystalline polyester in order to have a better low temperature fixability. A crystalline polyester is also produced as a polycondensation product of a polyol and a polycarboxylic acid described above.

An aliphatic diol is preferable as the polyol. Specific examples thereof include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol, and 1,4-butenediol. Among these, 1,4-butanediol, 1,6-hexanediol, and 1,8-octanediol are preferable, and 1,6-hexanediol is more preferable.

Preferable examples of the polycarboxylic acid include: aromatic dicarboxylic acid such as phthalic acid, isophthalic acid, and terephthalic acid; and aliphatic carboxylic acid having 2 to 8 carbon atoms. Aliphatic carboxylic acid is more preferable in order to achieve a high crystallinity.

A crystalline resin and a non-crystalline resin are distinguished from each other based on thermal properties thereof. A crystalline resin means a resin that shows an apparent endothermic peak in, for example, a DSC measurement, like a wax. On the other hand, a non-crystalline resin shows a gentle curve attributable to glass transition.

### <Modified Resin>

The binder resin may also contain a modified resin. The purposes for adding a modified resin include but are not limited to enhancing a mechanistic strength of toner particles, and in addition of enhancing a mechanistic strength, preventing hot offset during fixing. For example, toner particles may be produced by dissolving a modified resin having an isocyanate group at a terminal in an oil phase.

A modified resin may be produced, for example, by a method of polymerizing an isocyanate-containing monomer together with a compound reactive with the monomer to thereby obtain a resin having an isocyanate group, and a method of producing a polymer (prepolymer) having active hydrogen at a terminal by polymerization, and then reacting the prepolymer with polyisocyanate to thereby incorporate an isocyanate group at a terminal of the polymer. The latter method is preferable because of its controllability of incorporating an isocyanate group at a terminal.

Examples of the active hydrogen include hydroxyl (e.g., alcoholic hydroxyl, and phenolic hydroxyl), an amino group, a carboxyl group, and a mercapto group. Among these, alcoholic hydroxyl is preferable.

It is preferable that the skeleton of the modified resin be the same as the skeleton of the resin that dissolves in an organic medium, in terms of uniformity of the particles, and that the modified resin have a polyester skeleton (i.e. the modified resin be an isocyanate-modified polyester).

A prepolymer having an alcoholic hydroxyl group at a terminal of is polyester may be produced by, for example, a method of polycondensing a polyol and a polycarboxylic acid in a state that the number of functional groups of the polyol is greater than the number of functional groups of the polycarboxlic acid.

The polyisocyanate is not particularly limited, and an arbitrary polyisocyanate may be selected according to the purpose. Examples thereof include aliphatic polyisocyanate, alicyclic polyisocyanate, aromatic diisocyanate, aromatic aliphatic diisocyanate, isocyanurates, phenol derivative of these, and a product blocked with oxime, caprolactam, or the like. A preferable example of the alicyclic polyisocyanate is isophorone.

Functional groups of the modified resin (e.g., isocyanate-modified polyester) hydrolyze, and some of them turn to amino groups during the process of granulation (production of particles) performed by dispersing an oil phase containing the modified resin in an aqueous phase, and the produced amino groups react with unreacted isocyanate groups to thereby advance an elongation reaction.

In order to steadily advance an elongation reaction in addition to the above reaction, or in order to incorporate cross-linking points, it is possible to use an amine compound in combination. Examples of such an amine compound (B) include diamine (B1), trivalent or higher polyamine (B2), amino alcohol (B3), amino mercaptan (B4), amino acid (B5), and a product (B6) obtained by blocking an amino group of B1 to B5.

Examples of the diamine (B1) include: aromatic diamine (e.g., phenylene diamine, diethyltoluene diamine, 4,4′diaminodiphenylmethane, tetrafluoro-p-xylylene diamine, and tetrafluoro-p-phenylene diamine); alicyclic diamine (e.g., 4,4′-diamino-3,3′dimethyldicyclohexyl methane, diamine cyclohexane, and isophoronediamine); and aliphatic diamine (e.g., ethylene diamine, tetramethylene diamine, hexamethylenediamine, dodecafluorohexylene diamine, and tetracosafluorododecylene diamine).

Examples of the trivalent or higher polyamine (B2) include diethylenetriamine, and triethylene tetramine.

Examples of the amino alcohol (B3) include ethanol amine, and hydroxyethyl aniline.

Examples of the amino mercaptan (B4) include aminoethyl mercaptan, and amino propyl mercaptan.

Examples of the amino acid (B5) include aminopropionic acid, and aminocaproic acid.

Examples of the product (B6) obtained by blocking an amino group of B1 to B5 include a ketimine compound and an oxazoline compound that are produced from amines and ketones (e.g., acetone, methyl ethyl ketone, and methyl isobutyl ketone) of B1 to B5.

Among these amines (B), B1, and a mixture of B1 with a small amount of B2 are preferable.

A ratio of the amine (B), which is represented by the number of amino groups [NHx] in the amine (B), is 4 or less times, preferably 2 or less times, more preferably 1.5 or less times, and yet more preferably 1.2 or less times as large as the number of isocyanate groups [NCO] in a prepolymer (A) having isocyanate groups. When the number of amino groups is more than 4 times as large, the isocyanates may be blocked with excessive amino groups to prohibit an elongation reaction, which suppresses the molecular weight of the polyester and degrades hot offset resistance.

The amine compound is an active hydrogen group-containing compound reactive with a modified resin (e.g., isocyanate-modified polyester). Such an active hydrogen group-containing compound is not particularly limited, and an arbitrary active hydrogen group-containing compound may be selected according to the purpose. Examples of the active hydrogen group include an amino group, hydroxyl (alcoholic hydroxyl or phenolic hydroxyl), a carboxyl group, and a mercapto group. One of these may be used alone, or two or more of these may be used in combination.

The active hydrogen group-containing compound and a modified resin reactive with the compound (isocyanate-modified polyester) can be comprehended as a so-called binder resin precursor.

A reaction terminating agent is used to terminate an elongation reaction, a cross-linking reaction, etc. between a modified resin (e.g., isocyanate-modified polyester) and the active hydrogen group-containing compound. Use of a reaction terminating agent is preferable because this makes it possible to control the molecular weight, etc. of an adhesive base material to within a desired range. A monoamine (e.g., diethylamine, dibutyl amine, butyl amine, and lauryl amine), or a blocked product of a monoamine (e.g., a ketimine compound) may be used as the reaction terminating agent.

### (Colorant)

A colorant used as a constituent component of the toner of the present invention is not particularly limited, and a publicly-known dye or pigment may be used. Example of the colorant include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. One of these may be used alone, or two or more of these may be used in combination.

The colorant may be used in an amount that is within a range in which a color intended as a toner can be produced after fixing, and in which fixability, storage stability, and a granulation performance are not inhibited. Black is preferably in an amount of from 7 parts by mass to 9 parts by mass relative to 100 parts by mass of the toner, and any other color is preferably in an amount of from 5 parts by mass to 8 parts by mass relative to 100 parts by mass of the toner. A colorant amount equal to or smaller than the predetermined amount is preferable because a desired hue can be produced, and in terms of a granulation performance.

### [Master Batch of Colorant]

The colorant used in the present invention may be used as a master batch in which it is combined with a resin. Examples of a binder resin that is used for production of a master batch or that is kneaded together with a master batch include: the modified resin given above (e.g., isocyanate-modified polyester), unmodified polyester, and a polymer of styrene or of a styrene derivative, such as polystyrene, poly p-chlorostyrene, and polyvinyl toluene; a styrene copolymer such as a styrene/p-chlorostyrene copolymer, a styrene/propylene copolymer, a styrene/vinyl toluene copolymer, a styrene/vinyl naphthalene copolymer, a styrene/methyl acrylate copolymer, a styrene/ethyl acrylate copolymer, a styrene/butyl acrylate copolymer, a styrene/octyl acrylate copolymer, a styrene/methyl methacrylate copolymer, a styrene/ethyl methacrylate copolymer, a styrene/butyl methacrylate copolymer, a styrene/methyl α-chloromethacrylate copolymer, a styrene/acrylonitrile copolymer, a styrene/methyl vinyl ketone copolymer, a styrene/butadiene copolymer, a styrene/isoprene copolymer, a styrene/acrylonitrile/indene copolymer, a styrene/maleic acid copolymer, and a styrene/maleate copolymer; polymethyl methacrylate; polybutyl methacrylate; polyvinyl chloride, polyvinyl acetate; polyethylene; polypropylene; polyester; an epoxy resin; an epoxy polyol resin; polyurethane; polyamide; polyvinyl butyral; a polyacrylic acid resin; rosin; modified rosin; a terpene resin; an aliphatic or alicyclic hydrocarbon resin; an aromatic petroleum resin; a chlorinated paraffin; and a paraffin wax. These resins may be used alone, or as a mixture.

### [Master Batch Production Method]

It is possible to produce a master batch by mixing and kneading a master batch resin and a colorant under a high shearing force. Here, it is preferable to add an organic solvent in order to enhance an interaction between the colorant and the resin. Further, a so-called flushing method is preferable because this method can use a wet cake of the colorant as is without drying it. This flushing method is a method of mixing or kneading a water-containing aqueous paste of the colorant together with a resin and an organic solvent, transferring the colorant to the resin, and removing the water component and the organic solvent component. It is preferable to use a high shearing force disperser such as a three-roll mill for the mixing or the kneading.

### (Release Agent)

The static charge image developing toner of the present invention may contain a release agent in a main portion thereof in order to have an increased fixing releasability. The release agent is not particularly limited, and an arbitrary release agent may be selected according to the purpose, but a substance such as a wax and a silicone oil that has a sufficiently low viscosity when heated during a fixing process, and that is unlikely to compatibilize or swell on a surface of a fixing member together with the other substances in the toner particles is used. It is preferable to use a wax that is present in the toner particles in the form of a solid under typical storage conditions, in terms of the heat resistant storage stability of the toner particles themselves.

Examples of the wax include long-chain hydrocarbon and a carbonyl group-containing wax.

Examples of the long-chain hydrocarbon includes a polyolefin wax (e.g., a polyethylene wax, and a polypropylene wax), a petroleum wax (e.g., a paraffin wax, a Sasol wax, and a microcrystalline wax), and a Fischer-Tropsch wax.

Examples of the carbonyl group-containing wax include: a polyalkanoic acid ester (e.g., a carnauba wax, a montan wax, trimethylolpropane tribehenate, pentaerythritol tetrabehenate, pentaerythritol diacetate dibehenate, glycerin tribehenate, and 1,18-octadecanediol distearate); a polyalkanol ester (e.g., tristearyl trimellitate, and distearyl maleate); a polyalkanoic acid amide (e.g., ethylene diamine dibehenyl amide); a polyalkyl amide (e.g., tristearylamide trimellitate); and dialkyl ketone (e.g., distearyl ketone).

Among these, a long-chain hydrocarbon having a good releasability is particularly preferable. It is also possible to use a carbonyl group-containing wax in combination, when using a long-chain hydrocarbon as a release agent. The content of the release agent in the toner particles is from 2% by mass to 25% by mass, preferably from 3% by mass to 20% by mass, and more preferably from 4% by mass to 15% by mass. When the content is 2% by mass or greater, an effect of improving fixing releasability is exhibited. When the content is 25% by mass or less, a mechanical strength of the toner particles is high.

### (Charge Controlling Agent)

A charge controlling agent may be used in order to impart a high charge to the toner. Any publicly-known charge controlling agent may be used as the charge controlling agent. Examples thereof include a nigrosine dye, a triphenylmethane dye, a chromium-containing metal complex dye, a molybdic acid chelate pigment, a rhodamine dye, an alkoxy amine, a quaternary ammonium salt (including a fluorine-modified quaternary ammonium salt), an alkyl amide, phosphorus or a phosphorus compound, tungsten or a tungsten compound, a fluorine-based active agent, a salicylic acid metal salt, a salicylic acid derivative metal salt, and calixarene.

The charge controlling agent may be a commercially available product. Examples of commercially available products include nigrosine dye BONTRON 03, quaternary ammonium salt BONTRON P-51, metal-containing azo dye BONTRON S-34, oxynaphthoic acid-based metal complex E-82, salicylic acid-based metal complexes E-84, E-108, and E-304 (all manufactured by ORIENT CHEMICAL INDUSTRIES CO., LTD); quaternary ammonium salt molybdenum complex TP-302 and TP-415 (all manufactured by Hodogaya Chemical Co., Ltd.); quaternary ammonium salt COPY CHARGE PSY VP 2038, triphenylmethane derivative COPY BLUE PR, quaternary ammonium salt COPY CHARGE NEG VP2036 and COPY CHARGE NX VP434 (all manufactured by Hoechst AG); LRA-901; boron complex LR-147 (manufactured by Japan Carlit Co., Ltd.); copper phthalocyanine; perylene; quinacridone; azo-pigments; and polymeric compounds having, as a functional group, a sulfonic acid group, carboxyl group, quaternary ammonium salt, etc. One of these may be used alone, or two or more of these may be used in combination.

The content of the charge controlling agent varies depending on the kinds of the resins, presence or absence of an additive, a dispersion method, etc., and cannot be determined flatly. However, for example, the content thereof is preferably from 0.1 parts by mass to 10 parts by mass, and more preferably from 0.2 parts by mass to 5 parts by mass, relative to 100 parts by mass of the binder resin. When the content of the charge controlling agent is less than 0.1 parts by mass, a charge controlling property may not be obtained. When the content thereof is greater than 10 parts by mass, the toner may have an excessively high chargeability, to degrade the effect of a main charge controlling agent, have a greater electrostatic attractive force to attract a developing roller, and bring about degradation of flowability of the developer, and degradation of image density.

### (External Additive)

It is preferable to use publicly-known inorganic particles and polymeric particles as an external additive. A primary particle diameter of the external additive is preferably from 5 nm to 2 μm, and particularly preferably from 5 nm to 500 nm. A specific surface area of the external additive measured according to a BET method is preferably from 20 m²/g to 500 m²/g. The additive ratio of the external additive is preferably from 0.01% by mass to 5% by mass, and particularly preferably from 0.01% by mass to 0.2% by mass of the toner.

Specific examples of the inorganic particles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red ocher, antimony trioxide, magnesium oxide, zirconium oxide, barium sulfate, barium carbonate, calcium carbonate, silicon carbide, and silicon nitride. One of these may be used alone, or two or more of these may be used in combination.

Examples of the polymeric particles include: a polycondensation product such as polystyrene, methacrylic acid ester, an acrylic acid ester copolymer, silicone, benzoguanamine, and Nylon (Registered Trademark) which are produced by soap-free emulsion polymerization, suspension polymerization, or dispersion polymerization; and polymer particles made of a thermosetting resin.

### [Flowability Improver]

A flowability improver is an agent that has been subjected to a surface treatment to have a greater hydrophobicity, to thereby prevent degradation of flowability and chargeability even under high humidity conditions. Preferable examples of surface treatment agents for the surface treatment include a silane coupling agent, a silylation agent, a silane coupling agent having an alkyl fluoride group, an organic titanate-based coupling agent, an aluminium-based coupling agent, a silicone oil, and a modified silicone oil. It is particularly preferable that silica and titanium oxide as a flowability improver be subjected to a surface treatment with such a surface treatment agent, and be used as hydrophobic silica and hydrophobic titanium oxide.

### [Cleanability Improver]

A cleanability improver is an agent added in the toner to remove a developer after having transferred, which remains on the photoconductor or a first transfer medium. Examples of the cleanability improver include: a fatty acid metal salt such as zinc stearate, calcium stearate, and stearic acid; and polymer particles produced by soap-free emulsion polymerization, such as polymethyl methacrylate particles and polystyrene particles. Polymer particles having a relatively narrow granularity distribution are preferable, and polymer particles having a volume average particle diameter of from 0.01 μm to 1 μm are preferable.

### (Method for Producing Toner)

A method for producing the toner is not particularly limited, and examples thereof include: publicly-known wet granulation methods such as a dissolution suspension method, a suspension polymerization method, and an emulsion aggregation method; and a pulverization method. A dissolution suspension method and an emulsion aggregation method (emulsion polymerization method) are preferable because it is easy to control a particle diameter and a shape with these methods. An example of a method for producing the toner of the present invention will be explained below specifically. The present invention is not limited to the toner producing method illustrated below.

### (Oil Phase Producing Step)

A method for producing an oil phase in which a binder resin, a colorant, etc. are dissolved or dispersed with an organic solvent may be performed by gradually adding the binder resin, the colorant, etc. to the organic solvent while stirring them, to thereby dissolve or disperse the binder resin, the colorant, etc. in the organic solvent. However, in the case of using a pigment as the colorant, or adding any agent among a release agent, a charge controlling agent, etc. that is sparingly soluble in the organic solvent, it is preferable to reduce the size of the particles before adding them to the organic solvent.

Preparation of the colorant in the form of a master batch described above is also one of the production methods. It is also possible to extend a similar method to the release agent and the charge controlling agent.

As another method, it is also possible to perform wet dispersion of dispersing the colorant, the release agent, and the charge controlling agent in an organic solvent with addition of a dispersion auxiliary if necessary, to thereby obtain a wet master.

As yet another method, in the case of dispersing a substance that melts below the boiling point of an organic solvent, it is possible to add the dispersoid, and a dispersion auxiliary if necessary, to the organic solvent, heat them in the organic solvent while stirring them to dissolve the dispersoid once, and after this, cooling them while stirring or shearing them to crystallize the dispersoid, to thereby produce a microcrystal of the dispersoid.

The toner materials such as the colorant, the release agent, and the charge controlling agent that are dispersed by any method described above may be, after dissolved or dispersed in the organic solvent together with the resins, further dispersed. A publicly-known disperser such as a bead mill and a disk mill may be used for the dispersion.

### <Organic Solvent>

The organic solvent in which the toner materials are dissolved or dispersed is not particularly limited, and an arbitrary organic solvent may be selected according to the purpose as long as it can have the toner materials dissolved or dispersed. However, a preferable organic solvent is a volatile solvent having a boiling point of lower than 100° C., because such an organic solvent can be easily removed during or after granulation of the toner.

Examples of such an organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. One of these may be used alone, or two or more of these may be used in combination.

When a resin to be dissolved or dispersed in the organic solvent is a resin having a polyester skeleton, preferable examples of the organic solvent are ester solvents such as methyl acetate, ethyl acetate, and butyl acetate, or ketone solvents such as methyl ethyl ketone and methyl isobutyl ketone, because solubility is high. Among these, methyl acetate, ethyl acetate, and methyl ethyl ketone that are high in solvent removability are particularly preferable.

### <Aqueous Medium>

Water may be used alone as an aqueous medium, but a solvent miscible with water may be used in combination. The solvent miscible with water is not particularly limited, except that it should be miscible with water. Examples thereof include alcohol (e.g., methanol, isopropanol, and ethylene glycol), dimethyl formamide, tetrahydrofuran, cellosolves (e.g., methyl cellosolve), and lower ketones (e.g., acetone, and methyl ethyl ketone). One of these may be used alone, or two or more of these may be used in combination.

A surfactant, an inorganic dispersant, and a protective colloid (organic resin particles) may be used in combination with the aqueous medium.

### <Surfactant>

A surfactant is used to disperse the oil phase in the aqueous medium and produce liquid droplets.

Examples of the surfactant include an anionic surfactant, a cationic surfactant, and an amphoteric surfactant.

Examples of the anionic surfactant include alkylbenzene sulfonic acid salt, a-olefin sulfonic acid salt, and phosphoric acid ester.

Examples of the cationic surfactant include an amine salt-based cationic surfactant, and a quaternary ammonium salt-based cationic surfactant. Examples of the amine salt-based cationic surfactant include an alkyl amine salt, an amino alcohol fatty acid derivative, a polyamine fatty acid derivative, and imidazoline. Examples of the quaternary ammonium salt-based cationic surfactant include an alkyl trimethyl ammonium salt, a dialkyl dimethyl ammonium salt, an alkyl dimethyl benzyl ammonium salt, a pyridinium salt, an alkyl isoquinolinium salt, and benzethonium chloride.

Examples of the amphoteric surfactant include: a nonionic surfactant such as a fatty acid amide derivative, and a multivalent alcohol derivative; alanine; dodecyldi(aminoethyl)glycine; di(octylaminoethyl)glycine, and N-alkyl-N,N-dimethyl ammonium betaine.

### <Inorganic Dispersant>

The oil phase containing the toner materials (i.e., a dissolved or dispersed product of a toner composition) may be dispersed in the aqueous medium in the presence of an inorganic dispersant or resin particles. Examples of the inorganic dispersant include tricalcium phosphate, calcium carbonate, titanium oxide, colloidal silica, and hydroxyapatite. It is preferable to use a dispersant, because a granularity distribution will be sharp, and dispersion will be stable.

### <Protective Colloid>

Examples of the protective colloid include a polymeric protective colloid such as organic resin particles. Such a protective colloid may be made present in the aqueous medium to stabilize the droplets of the dispersion liquid.

In the present invention, an Example in which a styrene/acrylate copolymer (e.g., a copolymer of styrene/methacrylic acid/butyl acrylate/methacrylic acid ethylene oxide adduct sulfate sodium salt) is used as the organic resin particles, and an Example in which polyester is used as the organic resin particles will be described. However, the present invention is not limited to these Examples.

Other examples of a resin to constitute the protective colloid include a homopolymer or a copolymer of monomers given below.

Examples of the monomers include: acids such as acrylic acid, methacrylic acid, a-cyanoacrylic acid, itaconic acid, crotonic acid, fumaric acid, and maleic acid or maleic anhydride; a (meth)acrylic monomer having a hydroxyl (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid ester, diethylene glycol monomethacrylic acid ester, glycerin monoacrylic acid ester, glycerin monomethacrylic acid ester, N-methylol acrylamide, and N-methylol methacrylamide); vinyl alcohol or vinyl alcohol ethers (e.g., vinyl methyl ether, vinyl ethyl ether, and vinyl propyl ether), or esters of compounds containing vinyl alcohol and a carboxyl group (e.g., vinyl acetate, vinyl propionate, and vinyl butyrate); acrylamide, methacrylamide, and diacetone acrylamide, or methylol compounds of these; acid chlorides (e.g., acrylic acid chloride, and methacrylic acid chloride); and a nitrogen atom and a substance having a heterocycle containing a nitrogen atom (e.g., vinyl pyridine, vinyl pyrrolidone, vinyl imidazole, and ethyleneimine).

Other examples of a resin to constitute the protective colloid include: polyethylene-based substances (e.g., polyoxyethylene, polyoxypropylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearylphenyl ester, and polyoxyethylene nonylphenyl ester); and celluloses (e.g., methyl cellulose, hydroxyethyl cellulose, and hydroxypropyl cellulose).

In the case of using a dispersion stabilizer, such as calcium phosphate salt, that is soluble in an acid and an alkali, the calcium phosphate salt is dissolved with an acid such as hydrochloric acid, and then removed from the produced particles by means of washing with water, or the like. The dispersion stabilizer may also be removed with such an operation as enzymatic decomposition. When a dispersion stabilizer is used, the dispersion stabilizer may be left in a surface of the toner particles, but when a reactive precursor is used as a binder resin component, it is more preferable that it be washed and removed after the reactive precursor undergoes elongation, cross-linking, or both thereof, in terms of toner chargeability.

However, it is preferable to perform control such that the organic resin particles may be present in a surface of the toner. That is, it is preferable to perform control such that the organic resin particles may remain in a surface of the toner that is obtained by dispersing and granulating the oil phase containing the binder resin in the organic solvent, in the aqueous medium containing the organic resin particles as the protective colloid agent.

### (Toner Producing Step)

A method for dispersing the oil phase obtained in the step described above in the aqueous medium containing at least the surfactant and the polymeric protective colloid, to thereby produce a dispersion liquid in which a toner main portion composed of the oil phase is dispersed is not particularly limited. Examples thereof include publicly-known equipments such as a low-speed shearing system, a high-speed shearing system, a friction system, a high-pressure jetting system, and ultrasonic waves.

A high-speed shearing system is preferable in order to obtain a dispersion having a particle diameter of from 2 μm to 20 μm. When a high-speed shearing system is used, the rotation speed thereof is not particularly limited, but is typically from 1,000 rpm to 30,000 rpm, and preferably from 5,000 rpm to 20,000 rpm. The dispersion time is not particularly limited, but is typically from 0.1 minutes to 5 minutes in the case of a batch system. When the dispersion operation is performed for longer than 5 minutes, particles having a small diameter that is undesirable may remain, or the dispersion operation may result in an excessively dispersed state, to make the system unstable and produce aggregates and coarse particles, which is undesirable.

The temperature during the dispersion operation is typically from 0° C. to 40° C., and preferably from 10° C. to 30° C. When the temperature becomes higher than 40° C., molecular motions become active, to degrade the dispersion stability and make it more likely to produce aggregates and coarse particles, which is unfavorable. When the temperature becomes lower than 0° C., the viscosity of the dispersion becomes higher, to increase the shearing energy required for the dispersion operation, which lowers the production efficiency.

The surfactant may be any of those described above. However, a disulfonic acid salt-based surfactant having a high HLB is preferable in order to disperse the oil droplets containing the solvent efficiently. The concentration of the surfactant in the aqueous medium is from 1% by mass to 10% by mass, preferably from 2% by mass to 8% by mass, and more preferably from 3% by mass to 7% by mass. When the concentration is higher than 10% by mass, the oil droplets may become excessively small, or a reverse micelle structure may be formed to degrade the dispersion stability against the intention to thereby coarsen the oil droplets, which is unfavorable. When the concentration is lower than 1% by mass, oil droplets may not undergo stable dispersion and may be coarsened, which is unstable.

As the polymeric protective colloid, organic resin particles of a styrene/acrylate copolymer, and organic resin particles of polyester are preferable.

### <Organic Solvent Removing Step>

The organic solvent is removed from an emulsified slurry (core particle slurry) obtained through emulsification or dispersion. Examples of a method for removing the organic solvent include (1) a method of gradually raising the temperature of the whole reaction system to thereby vaporize and remove the organic solvent in the oil droplets completely, and (2) a method of spraying the emulsified dispersion into a dry atmosphere to remove the water-insoluble organic solvent in the oil droplets completely and form toner particles, while vaporizing and removing any aqueous dispersant at the same time. When the organic solvent is removed, a dispersion slurry is formed.

### <Washing Step>

After the dispersion slurry is formed by removing the organic solvent, the formed dispersion slurry is washed with ion-exchanged water, to thereby produce a filtration cake having a desired conductivity.

### <Drying Step>

The washed filtration cake (toner particles) contains the aqueous medium in a large amount. Therefore, it is possible to obtain only the toner particles by removing the aqueous medium by drying. Examples of the drying method include a spray dryer, a vacuum-freeze dryer, a vacuum dryer, a static shelf dryer, a movable shelf dryer, a fluid bed dryer, a rotational dryer, and a stirring dryer.

It is preferable to dry the toner particles until finally the moisture content thereof becomes lower than 1%. The dried toner particles have formed soft aggregates, which may be loosened by pulverization with equipment such as a jet mill, a Henschel mixer, a super mixer, a coffee mill, an Oster blender, and a food processor, if the soft aggregates may cause a trouble during use. The pulverized toner particles are sieved through a predetermined mesh to a uniform particle diameter.

It is possible to mix the toner particles obtained through these steps with particles of the flowability improver, the cleanability improver, etc. described above, or add the external additive to the surface of the toner particles by application of a mechanical impact.

### (Toner Particle Diameter)

In order for the toner of the present invention to be electrically charged uniformly and sufficiently, the volume average particle diameter of the toner is from 3 μm to 9 μm, preferably from 4 μm to 8 μm, and more preferably from 4 μm to 7 μm. When the volume average particle diameter is less than 3 μm, the attaching force of the toner is high relatively, which is unfavorable because controllability of the toner with an electric field is poor. When it is greater than 9 μm, an image grade such as fine line reproducibility is poor.

A ratio between the volume average particle diameter and a number average particle diameter of the toner (volume average particle diameter/number average particle diameter) is preferably 1.25 or less, more preferably 1.20 or less, and yet more preferably 1.17 or less. When the ratio is greater than 1.25, uniformity of the particle diameter of the toner is low, which makes it likely to cause variation in the size of the convex. Further, through repeated use, toner particles having a large particle diameter, or as the case may be, toner particles having a small particle diameter may be used up to change the average particle diameter among the unused toner particles in a developing device, in which case, conditions optimized for development may become wrong for the unused toner particles, making it likely for such phenomena as a charging failure, an extremely low or high conveyance amount, toner clogging, and contamination by the toner, to occur.

Examples of the instrument for measuring the granularity distribution of the toner particles include COULTER COUNTER TA-II and COULTER MULTISIZER II (both manufactured by Coulter, Inc.).

First, a surfactant (preferably, an alkyl benzene sulfonic acid salt) (from 0.1 ml to 5 ml) is added as a dispersant into an electrolysis aqueous solution (from 100 ml to 150 ml). The electrolysis solution is prepared as an about 1% NaCl aqueous solution using primary sodium chloride, and may be ISOTON-II (manufactured by Coulter, Inc.). Then, a measurement sample (from 2 mg to 20 mg) is added into the electrolysis solution. The electrolysis solution in which the sample is suspended is subjected to a dispersion operation with an ultrasonic disperser for about 1 minute to 3 minutes. Then, with the measurement instrument described above, the volume and the number of toner particles or of the toner are measured with a 100 μm aperture, and a volume distribution and a number distribution are calculated. A volume average particle diameter (D4) and a number average particle diameter (D1) of the toner can be calculated from the obtained distributions.

Channels used are 13 channels, namely channels of from 2.00 μm or greater but less than 2.52 μm; from 2.52 μm or greater but less than 3.17 μm; from 3.17 μm or greater but less than 4.00 μm; from 4.00 μm or greater but less than 5.04 μm; from 5.04 μm or greater but less than 6.35 μm; from 6.35 μm or greater but less than 8.00 μm; from 8.00 μm or greater but less than 10.08 μm; from 10.08 μm or greater but less than 12.70 μm; from 12.70 μm or greater but less than 16.00 μm; from 16.00 μm or greater but less than 20.20 μm; from 20.20 μm or greater but less than 25.40 μm; from 25.40 μm or greater but less than 32.00 μm; and from 32.00 μm or greater but less than 40.30 μm. The target particles are of a particle diameter of from 2.00 μm or greater but less than 40.30 μm.

### (Toner Shape)

An average circularity of the toner is 0.930 or greater, preferably 0.950 or greater, and more preferably 0.970 or greater. When the average circularity is less than 0.930, flowability of the toner is low, and it becomes likely for troubles to occur during development. Further, a transfer efficiency of the toner is also low.

The average circularity of the toner is measured with a flow-type particle image analyzer FPIA-2000. As a specific measurement method, a surfactant, preferably an alkyl benzene sulfonic acid salt (from 0.1 ml to 0.5 ml) is added as a dispersant into water (from 100 ml to 150 ml) in a vessel from which impurity solids have been previously removed, and a is measurement sample (from about 0.1 g to 0.5 g) is further added thereto. The suspension liquid in which the sample is dispersed is subjected to a dispersion operation with an ultrasonic disperser for about 1 minute to 3 minutes, until the concentration of the dispersion liquid becomes from 3,000 particles/μl to 10,000 particles/μl. Then, the shape and distribution of the toner are measured with the instrument described above. In this way, the average circularity of the toner can be obtained.

A toner that is produced by a wet granulation method, and that hence has an ionic toner constituent material thereof distributed unevenly about the surface thereof has a relatively low resistance in the surface layer thereof as a result, to be thereby able to have a high charging speed and a good charge rising property, but also has a problem that a charge retention property thereof is poor, i.e., the amount of charges built up in the toner is likely to decay rapidly. To overcome this problem, there is a method of having the toner carry a surface modifier on the surface thereof.

### (Measurement of Solid Content Concentration)

A solid content concentration of the oil phase is measured in the way described below. The oil phase (about 2 g) is put within 30 seconds on an aluminum dish of which mass has been weighed accurately beforehand (from about 1 g to 3 g), and the mass of the oil phase put thereon is weighed accurately. They are put in an oven of 150° C. for 1 hour to vaporize the solvent, and after this, they are taken out from the oven and left to be cooled, and the total mass of the aluminium dish and the oil phase solid content is measured with an electronic balance. The mass of the aluminium dish is subtracted from the total mass of the aluminium dish and the oil phase solid content to calculate the mass of the oil phase solid content, and the obtained mass is divided by the mass of the oil phase that has been put, to thereby calculate the solid content concentration of the oil phase. A ratio of the amount of the solvent to the amount of the solid content in the oil phase is a value obtained by dividing a value (solvent mass) obtained by subtracting the mass of the oil phase solid content from the mass of the oil phase, by the mass of the oil phase solid content.

### <Image Forming Apparatus/Image Forming Method>

An image forming apparatus of the present invention is an image forming apparatus that includes a latent image bearer configured to bear a latent image, a charging unit configured to electrically charge the surface of the latent image bearer, an exposure unit configured to write an electrostatic latent image on the electrically charged surface of the latent image bearer, a developing unit containing a toner and configured to supply the toner to the electrostatic latent image formed on the surface of the latent image bearer, and develop the electrostatic latent image to form a toner image, a transfer unit configured to transfer the toner image developed on the surface of the latent image bearer onto a receiving member, and a fixing unit configured to fix the toner image on the receiving member thereon. The toner is the static charge image developing toner of the present invention.

The image forming apparatus may include other units appropriately selected according to necessity, for example, a charge eliminating unit, a cleaning unit, a recycling unit, and a control unit. The charging unit is able to electrically charge the surface of the latent image bearer uniformly. The exposure unit is able to expose the electrically charged surface of the latent image bearer to light based on image data and write an electrostatic latent image.

An image forming method of the present invention includes a charging step of electrically charging a surface of a latent image bearer, an exposure step of writing an electrostatic latent image on the electrically charged surface of the latent image bearer, a developing step of supplying a toner to the electrostatic latent image formed on the surface of the latent image bearer, and developing the electrostatic latent image to form a toner image, a transfer step of transferring the toner image on the surface of the latent image bearer onto a receiving member, and a fixing step of fixing the toner image on the receiving member thereon. The toner is the static charge image developing toner of the present invention.

The image forming method may include other steps appropriately selected according to necessity, for example, a charge eliminating step, a cleaning step, a recycling step, and a control step. The charging step is a step of electrically charging the surface of the latent image bearer uniformly. The exposure step is a step of exposing the electrically charged surface of the latent image bearer to light based on image data to write an electrostatic latent image.

Formation of an electrostatic latent image can be performed by, for example, electrically charging the surface of the latent image bearer uniformly with the charging unit, and after this, exposing the surface to light imagewise with the exposure unit. Formation of a visible image by development is performed by forming a toner layer over a developing roller as a developer bearer, and conveying the toner layer over the developing roller to bring it into contact with a photoconductor drum (abbreviated as “photoconductor”), which is the latent image bearer, to thereby develop an electrostatic latent image on the photoconductor drum.

A toner is stirred by a stirring unit and supplied mechanically to a developer supply member. The toner supplied by the developer supply member and deposited over the developer bearer is formed into a uniform thin layer and also electrically charged by passing through a developer layer regulating member that is provided so as to abut on the surface of the developer bearer. The electrostatic latent image formed over the latent image bearer is developed to a toner image by having an electrically charged toner deposited thereon by the developing unit in a developing region. Transfer of the visible image can be performed by, for example, electrically charging the latent image over the latent image bearer (photoconductor) with a transfer charging device, and can be performed by the transfer unit. Fixing of the transferred visible image is performed by a fixing device for fixing a visible image transferred onto a recording medium, and may be performed for each color toner separately when it s transferred onto the recording medium, or may be performed simultaneously for all color toners in their overlaid state. The fixing device is not particularly limited, and an arbitrary fixing device may be selected according to the purpose. However, a publicly-known heating/pressurizing unit is preferable. Examples of the heating/pressurizing unit include a combination of a heating roller and a pressurizing roller, and a combination of a heating roller, a pressurizing roller, and an endless belt. Typically, heating by the heating/pressurizing unit is preferably to a temperature of from 80° C. to 200° C.

The basic configuration of the image forming apparatus (printer) according to an embodiment of the present invention will further be explained below with reference to the drawings.

FIG. 2 is a schematic diagram showing the configuration of the image forming apparatus according to an embodiment of the present invention. The embodiment to be explained here is an application as an electrophotographic image forming apparatus. The image forming apparatus is configured to form a color image using toners of four colors, namely yellow (hereinafter denoted as “Y”), cyan (hereinafter denoted as “C”), magenta (hereinafter denoted as “M”), and black (hereinafter denoted as “K”).

First, the basic configuration of the image forming apparatus (a tandem image forming apparatus) including a plurality of latent image bearers that are arranged side by side in a direction in which a surface motion member moves will be explained. The image forming apparatus includes four photoconductors 1Y, 1C, 1M, and 1K as the latent image bearers. Examples shown here are drum-shaped photoconductors, but belt-type photoconductors may also be employed. The photoconductors 1Y, 1C, 1M, and 1K are rotatably driven in the direction of the arrow in the drawing while maintaining contact with an intermediate transfer belt 10, which is a surface motion member. The photoconductors 1Y, 1C, 1M, and 1K are each formed of a relatively thin electroconductive base substrate having a cylindrical shape, a photoconductive layer formed over the base substrate, and a protective layer formed over the photoconductive layer. They may have an intermediate layer between the photoconductive layer and the protective layer.

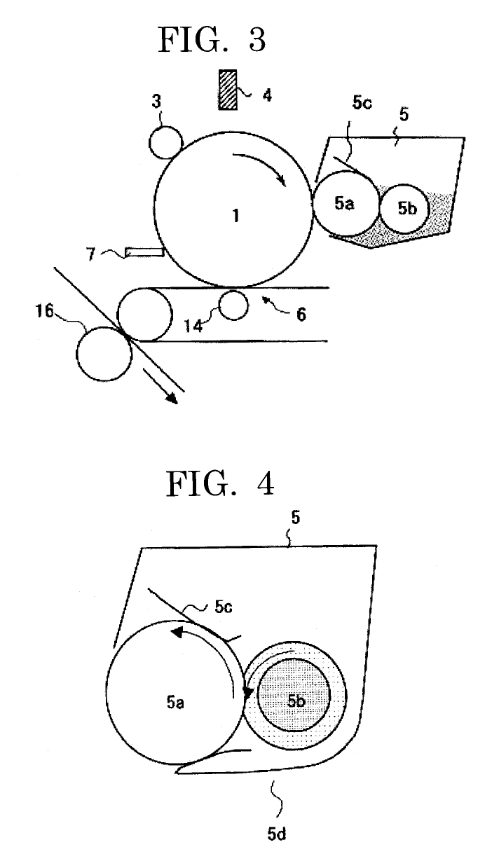

FIG. 3 is a schematic diagram showing a configuration of an image forming unit in which the photoconductor is provided. All image forming units 2Y, 2C, 2M, and 2K have the same constituent members around the photoconductors 1Y, 1C, 1M, and 1K. Therefore, the drawing shows only one image forming unit, with no color distinction signs Y, C, M, and K.

There are provided around the photoconductor 1 along a surface motion direction thereof, a charging device 3 as a charging unit, a developing device 5 as a developing unit, a transfer device 6 as a transfer unit configured to transfer a toner image over the photoconductor 1 onto a recording medium or the intermediate transfer belt 10, and a cleaning device 7 configured to remove any untransferred toner over the photoconductor 1, in this order.

A space is secured between the charging device 3 and the developing device 5 to allow light, which is emitted from an exposure device 4 as an exposure unit configured to write an electrostatic latent image, to pass through to the photoconductor 1. The charging device 3 electrically charges the surface of the photoconductor 1 to a negative polarity. The charging device 3 according to the present embodiment includes a charging roller as a charging member configured to perform a charging operation by a so-called contact/proximity charging method. That is, the charging device 3 brings the charging roller into contact with or to a proximity to the surface of the photoconductor 1 and applies a negative bias to the charging roller, to thereby electrically charge the surface of the photoconductor 1.

A direct-current charging bias that brings the photoconductor 1 to have a surface potential of −500 V is applied to the charging roller. The charging bias may also be a direct-current bias superimposed with an alternating-current bias. The charging device 3 may include a cleaning brush configured to clean the surface of the charging roller. As the charging device 3, a thin film may be wound over the circumferential surface of the charging roller at axial-direction both ends thereof, and such a charging device may be provided so as to abut on the surface of the photoconductor 1. With this configuration, the charging roller is in an extreme proximity to the photoconductor 1, with only a gap corresponding to the thickness of the film between the surface of the charging roller and the surface of the photoconductor. Hence, an electric discharge occurs between the surface of the charging roller and the surface of the photoconductor 1 due to a charging bias applied to the charging roller, and the surface of the photoconductor 1 is electrically charged as a result of the electric discharge.

The surface of the photoconductor 1 electrically charged in this way is exposed to light by the exposure device 4, and an electrostatic latent image corresponding to each color is formed over the surface. The exposure device 4 writes an electrostatic latent image corresponding to each color onto the photoconductor 1 based on image formation corresponding to each color. The exposure device 4 according to the present embodiment is a laser system, but a different system constituted by an LED array and an imaging unit may also be employed.

A toner replenished into the developing device 5 from a toner bottle 31Y, 31C, 31M, or 31K is conveyed by a developer supply roller 5b, and supported over a developing roller 5a. The developing roller 5a is conveyed to a region (hereinafter denoted as “developing region”) facing the photoconductor 1. The developing roller 5a makes a surface motion at a linear velocity higher than that of the surface of the photoconductor 1 in the same direction as that of the photoconductor. The developing roller 5a frictionally slides over the surface of the photoconductor 1 and supplies the toner thereon to the surface of the photoconductor 1. At the moment, a −300 V developing bias is applied to the developing roller 5a from an unillustrated power supply, and a developing electric field is formed in the developing region as a result. Hence, an electrostatic force acts in the toner over the developing roller 5a between the electrostatic latent image over the photoconductor 1 and the developing roller 5a, to make the toner move toward the electrostatic latent image. As a result, the toner over the developing roller 5a attaches to the electrostatic latent image over the photoconductor 1. Due to this attaching, the electrostatic is latent image over the photoconductor 1 is developed to a toner image having a corresponding color.

The intermediate transfer belt 10 of the transfer device 6 is tensed by three support rollers 11, 12, and 13, and configured to move endlessly in the direction of the arrow in the drawing. By an electrostatic transfer method, toner images over the respective photoconductors 1Y, 1C, 1M, and 1K are transferred onto the intermediate transfer belt 10 so as to be overlaid together. There is an electrostatic transfer system having a configuration using a transfer charger, but the configuration employed here uses a first transfer roller 14 that produces few transfer dust particles.

Specifically, as the transfer device 6, first transfer rollers 14Y, 14C, 14M, and 14K are provided at the back side of the portions of the intermediate transfer belt 10 that contact the photoconductors 1Y, 1C, 1M, and 1K. Here, first transfer nip portions are formed by the portions of the intermediate transfer belt 10 that are pressed by the first transfer rollers 14Y, 14C, 14M, and 14K and by the photoconductors 1Y, 1C, 1M, and 1K.

Then, in order for the toner images over the photoconductors 1Y, 1C, 1M, and 1K to be transferred onto the intermediate transfer belt 10, a positive bias is applied to the first transfer rollers 14. As a result, a transfer electric field is formed at the first transfer nip portions, and the toner images over the photoconductors 1Y, 1C, 1M, and 1K electrostatically attach to the intermediate transfer belt 10.

A belt cleaning device 15 configured to remove any residual toner over the surface of the intermediate transfer belt 10 is provided at a circumferential position of the intermediate transfer belt. The belt cleaning device 15 is configured to collect any unnecessary toner deposited over the surface of the intermediate transfer belt 10 with a fur brush and a cleaning blade. The collected unnecessary toner is conveyed by an unillustrated conveying unit from within the belt cleaning device 15 into an unillustrated waste toner tank. A second transfer roller 16 is provided at a portion of the intermediate transfer belt 10 that is tensed by the support roller 13 so as to contact the intermediate transfer belt.

A second transfer nip portion is formed between the intermediate transfer belt 10 and the second transfer roller 16, and a transfer sheet as a recording medium is delivered to this portion at a predetermined timing. The transfer sheet is contained in a paper feeding cassette 20 provided below the exposure device 4 in the drawing, and conveyed to the second transfer nip portion by a paper feeding roller 21, a registration roller pair 22, etc. The toner images overlaid together over the intermediate transfer belt 10 are simultaneously transferred onto the transfer sheet at the second transfer nip portion. At this second transferring, a positive bias is applied to the second transfer roller, and by a transfer electric field formed as a result, the toner images over the intermediate transfer belt 10 are transferred onto the transfer sheet. A heating fixing device 23 as a fixing unit is provided at a transfer sheet conveyance direction downstream side of the second transfer nip portion. The heating fixing device 23 includes a heating roller 23a having a built-in heater, and a pressurizing roller 23b for applying a pressure. The transfer sheet that has passed through the second transfer nip portion is sandwiched between these rollers, and receives heat and pressure. Hence, the toners put over the transfer sheet melt, and the toner images are fixed on the transfer sheet. The transfer sheet after fixed is ejected by a paper ejection roller 24 onto a paper ejection tray on the top surface of the apparatus.

The developing roller 5a as the developer bearer is partially exposed from an opening of the casing of the developing device 5. A one-component developer that does not contain a carrier is used here. The developing device 5 is replenished with a toner having the corresponding color from any of the toner bottles 31Y, 31C, 31M, and 31K shown in FIG. 2, and keeps the replenished toner therein. The toner bottles 31Y, 31C, 31M, and 31K are detachably mountable into the image forming apparatus body, so that they can be replaced independently.

With this configuration, it is only necessary to replace the toner bottles 31Y, 31C, 31M, and 31K at a toner end. Hence, any other constituent members that have not come to the end of life at a toner end can be used ongoingly, and the user can save expenditure.

FIG. 4 is a schematic diagram showing the configuration of the developing device 5 in FIG. 3. Being stirred by the developer supply roller 5b as a developer supply member, the developer (toner) in the developer container is conveyed to a nip portion of the developing roller 5a as a developer bearer configured to carry over the surface thereof, the developer to be supplied onto the photoconductor 1. At the moment, the developer supply roller 5b and the developing roller 5a are rotating in opposite directions from each other (counter rotations) at the nip portion therebetween. The amount of the toner over the developing roller 5a is regulated by a regulating blade 5c as a developer layer regulating member provided to abut on the developing roller 5a, and a thin toner layer is formed over the developing roller 5a. Further, the toner is frictioned at the nip portion between the developer supply roller 5b and the developing roller 5a, and between the regulating blade 5c and the developing roller 5a, and controlled to an adequate charge built-up amount.

A process cartridge of the present invention is a process cartridge that includes, as an integrated unit, a latent image bearer, and at least a developing unit configured to develop an electrostatic latent image over the latent image bearer with a toner, and that is detachably mountable into the image forming apparatus body. The toner is the static charge image developing toner of the present invention.

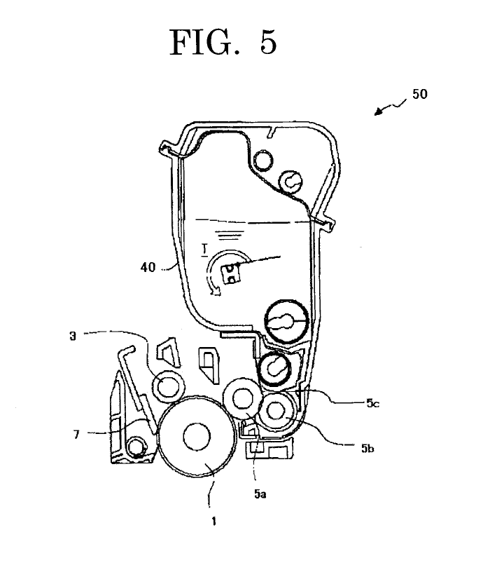

FIG. 5 is a schematic diagram showing an example of a configuration of the process cartridge according to an embodiment of the present invention. The toner of the present invention can be used in, for example, an image forming apparatus that includes such a process cartridge 50 as shown in FIG. 5. In the present invention, the process cartridge 50 is configured as an integrated unit of, among the constituent members, namely a latent image bearer, a charging unit, a developing device, etc., the latent image bearer, and at least the developing device configured to develop a latent image over the latent image bearer with the toner of the present invention, and is detachably mountable into the body of an image forming apparatus such as a copier, a printer, etc. The process cartridge shown in FIG. 5 includes a latent image bearer, a charging unit, and the developing device explained with reference to FIG. 4. In FIG. 5, the reference sign 40 denotes a developer container.

### EXAMPLES

The present invention will be explained below more specifically based on Examples. However, the present invention is not limited to Examples described below. Note that “part” described below represents “part by mass”, unless otherwise expressly specified.

In order to produce toners of Examples and Comparative Examples, binder resins 1 to 11 to be used as a toner constituent component were synthesized as follows.

### <Synthesis of Binder Resin 1>

A surfactant aqueous solution obtained by dissolving sodium dodecyl sulfate (4 parts by mss) in ion-exchanged water (3,040 parts by mass) was added in a reaction vessel having a cubic capacity of 5 L and equipped with a stirrer, a temperature sensor, a cooling tube, and a nitrogen introducing device. While the surfactant aqueous solution was stirred under nitrogen stream at a stirring speed of 230 rpm, the internal temperature was raised to 80° C. Then, a polymerization initiator solution obtained by dissolving potassium peroxide (KPS) (10 parts by mass) in ion-exchanged water (400 parts by mass) was added thereto, and after the liquid temperature was raised to 75° C., a polymerizable monomer solution containing styrene (532 parts by mass), n-butyl acrylate (200 parts by mass), and n-octyl mercaptan (16.4 parts by mass) was dropped thereinto in 1 hour, and the resultant was polymerized by being heated at 75° C. and stirred for 2 hours, to thereby prepare a resin particle dispersion liquid containing a binder resin. This solution was evaporated to dryness, to thereby obtain [Binder Resin 1], which was a styrene/acrylic copolymerized resin. The obtained binder resin 1 had a weight average molecular weight of 16,500.

### <Synthesis of Binder Resin 2>

[Binder Resin 2], which was a styrene/acrylic copolymerized resin, was obtained in the same manner as the synthesis of the binder resin 1, except that the additive amounts of styrene (532 parts by mass) and n-butyl acrylate (200 parts by mass) in the synthesis of the binder resin 1 were changed to those described below. The obtained binder resin 2 had a weight average molecular weight of 13,500.

Styrene: 432 parts by mass

n-butyl acrylate: 300 parts by mass

### <Synthesis of Binder Resin 3>

[Binder Resin 3], which was a styrene/acrylic copolymerized resin, was obtained in the same manner as the synthesis of the binder resin 1, except that the additive amounts of styrene (532 parts by mass) and n-butyl acrylate (200 parts by mass) in the synthesis of the binder resin 1 were changed to those described below. The obtained binder resin 3 had a weight average molecular weight of 18,000.

Styrene: 500 parts by mass

n-butyl acrylate: 220 parts by mass

### <Synthesis of Binder Resin 4>

[Binder Resin 4], which was a styrene/acrylic copolymerized resin, was obtained in the same manner as the synthesis of the binder resin 1, except that the additive amounts of styrene (532 parts by mass) and n-butyl acrylate (200 parts by mass) in the synthesis of the binder resin 1 were changed to those described below. The obtained binder resin 4 had a weight average molecular weight of 17,000.

Styrene: 500 parts by mass

n-butyl acrylate: 270 parts by mass

### <Synthesis of Binder Resin 5>

[Binder Resin 5], which was a styrene/acrylic copolymerized resin, was obtained in the same manner as the synthesis of the binder resin 1, except that the additive amounts of styrene (532 parts by mass) and n-butyl acrylate (200 parts by mass) in the synthesis of the binder resin 1 were changed to those described below. The obtained binder resin 5 had a weight average molecular weight of 16,500.

Styrene: 482 parts by mass

n-butyl acrylate: 250 parts by mass

### <Synthesis of Binder Resin 6>

A bisphenol A ethylene oxide 2 mol adduct (264 parts by mass), a bisphenol A propylene oxide 2 mol adduct (523 parts by mass), isophthalic acid (100 parts by mass), adipic acid (193 parts by mass), and dibutyl tin oxide (1 part by mass) were added in a reaction vessel equipped with a cooling tube, a stirrer, and a nitrogen introducing tube. They were reacted at normal pressure at 230° C. for 8 hours, and further reacted at reduced pressure of from 10 mmHg to 15 mmHg for 8 hours. After this, trimellitic anhydride (26 parts by mass) was added in the reaction vessel, and they were reacted at 180° C. at normal pressure for 2 hours, to thereby obtain [Binder Resin 6]. [Binder Resin 6] had a number average molecular weight of 4,000, a weight average molecular weight of 47,000, and an acid value of 12.

### <Synthesis of Binder Resin 7>

A bisphenol A ethylene oxide 2 mol adduct (264 parts by mass), a bisphenol A propylene oxide 2 mol adduct (523 parts by mass), terephthalic acid (100 parts by mass), adipic acid (193 parts by mass), and dibutyl tin oxide (1 part by mass) were added in a reaction vessel equipped with a cooling tube, a stirrer, and a nitrogen introducing tube. They were reacted at normal pressure at 230° C. for 8 hours, and further reacted at reduced pressure of from 10 mmHg to 15 mmHg for 8 hours. After this, trimellitic anhydride (26 parts by mass) was added in the reaction vessel, and they were reacted at 180° C. at normal pressure for 2 hours, to thereby obtain [Binder Resin 7]. [Binder Resin 7] had a number average molecular weight of 4,000, a weight average molecular weight of 47,000, and an acid value of 12.

### <Synthesis of Binder Resin 8>

A bisphenol A ethylene oxide 2 mol adduct (264 parts by mass), a bisphenol A propylene oxide 2 mol adduct (523 parts by mass), isopthalic acid (100 parts by mass), adipic acid (193 parts by mass), and dibutyl tin oxide (1 part by mass) were added in a reaction vessel equipped with a cooling tube, a stirrer, and a nitrogen introducing tube. They were reacted at normal pressure at 230° C. for 8 hours, and further reacted at reduced pressure of from 10 mmHg to 15 mmHg for 8 hours. After this, trimellitic anhydride (26 parts by mass) was added in the reaction vessel, and they were reacted at 180° C. at normal pressure for 2 hours. Ethyl isocyanate (25 parts by mass) was further added therein, and they were reacted at 180° C. at normal pressure for 3 hours, to thereby obtain [Binder Resin 8]. [Binder Resin 8] had a number average molecular weight of 4,000, a weight average molecular weight of 48,000, and an acid value of 10.

### <Synthesis of Binder Resin 9>

A bisphenol A ethylene oxide 2 mol adduct (264 parts by mass), a bisphenol A propylene oxide 2 mol adduct (523 parts by mass), isophthalic acid (100 parts by mass), adipic acid (193 parts by mass), and dibutyl tin oxide (1 part by mass) were added in a reaction vessel equipped with a cooling tube, a stirrer, and a nitrogen introducing tube. They were reacted at normal pressure at 230° C. for 8 hours, and further reacted at reduced pressure of from 10 mmHg to 15 mmHg for 8 hours. After this, trimellitic anhydride (26 parts by mass) was added in the reaction vessel, and they were reacted at 180° C. at normal pressure for 2 hours. Phenyl isocyanate (52 parts by mass) was further added therein, and they were reacted at 180° C. at normal pressure for 3 hours, to thereby obtain [Binder Resin 9]. [Binder Resin 9] had a number average molecular weight of 4,000, a weight average molecular weight of 49,000, and an acid value of 10.

### <Synthesis of Binder Resin 10>

[Binder Resin 10], which was a styrene/acrylic copolymerized resin, was obtained in the same manner as the synthesis of the binder resin 1, except that the additive amount of styrene (532 parts by mass) in the synthesis of the binder resin 1 was changed to the amount described below. The obtained binder resin 10 had a weight average molecular weight of 16,000.

Styrene: 562 parts by mass

<Synthesis of Binder Resin 11>

[Binder Resin 11], which was a styrene/acrylic copolymerized resin, was obtained in the same manner as the synthesis of the binder resin 1, except that the additive amounts of styrene (532 parts by mass) and n-butyl acrylate (200 parts by mass) in the synthesis of the binder resin 1 were changed to those described below. The obtained binder resin 11 had a weight average molecular weight of 15,000.

Styrene: 432 parts by mass

n-butyl acrylate: 330 parts by mass

### <Synthesis of Isocyanate-Modified Polyester>

A bisphenol A ethylene oxide 2 mol adduct (682 parts by mass), a bisphenol A propylene oxide 2 mol adduct (81 parts by mass), isophthalic acid (283 parts by mass), trimellitic anhydride (22 parts by mass), and dibutyl tin oxide (2 parts by mass) were added in a reaction vessel equipped with a cooling tube, a stirrer, and a nitrogen introducing tube. They were reacted at normal pressure at 230° C. for 8 hours. Next, they were reacted at reduced pressure of from 10 mmHg to 15 mmHg for 5 hours, to thereby synthesize [Intermediate Polyester 1].

The obtained [Intermediate Polyester 1] has a number average molecular weight of 2,200, a weight average molecular weight of 9,700, an acid value of 0.5 mgKOH/g, and a hydroxyl value of 52 mgKOH/g.

Next, [Intermediate Polyester 1] (410 parts by mass), isophorone diisocyanate (89 parts by mass), and ethyl acetate (500 parts by mass) were added in a reaction vessel equipped with a cooling tube, a stirrer, and a nitrogen introducing tube, and reacted at 100° C. for 5 hours, to thereby obtain [Isocyanate-Modified Polyester 1].

### <Production of Master Batch>

Carbon black (REGAL 400R manufactured by Cabot Corporation) (40 parts by mass), polyester (RS-801 manufactured by Sanyo Chemical Industries, Ltd., with an acid value of 10, mw of 20,000, and Tg of 64° C.) (60 parts by mass), and water (30 parts by mass) were mixed with a Henschel mixer, to thereby obtain a mixture in which pigment aggregates were soaked with water. The mixture was kneaded with two rolls of which roll surface temperature was set to 130° C. for 45 minutes, and pulverized with a pulverizer to a size of 1 mm, to thereby obtain [Master Batch 1].

### Example 1

A toner 1 of Example 1 was produced through the steps described below.

### Steps for Producing Toner 1

### <Oil Phase Producing Step>

[Binder Resin 1] (545 parts), [Paraffin Wax (with a melting point of 74° C.)] (181 parts), and ethyl acetate (1,450 parts) were added in a vessel equipped with a stirring bar and a thermometer, raised to a temperature of 80° C. while being stirred, retained at 80° C. for 5 hours, and cooled to 30° C. in 1 hour. Next, [Master Batch 1] (500 parts), and ethyl acetate (100 parts) were added in the vessel, and they were mixed for 1 hour, to thereby obtain [Material Dissolved Liquid 1].

[Material Dissolved Liquid 1] (1,500 parts) was changed to another vessel, and the pigment and the wax were subjected to a dispersion operation with a beads mill (ULTRAVISCO MILL manufactured by Imex Co.), at a liquid sending speed of 1 kg/hr, at a disk peripheral velocity of 6 m/second, with 0.5 mm zirconia beads packed to 80% by volume, and for 3 passes. Next, a 66% ethyl acetate solution of [Binder Resin 1] (655 parts) were added thereto, and they were processed with the beads mill at the conditions described above for 1 pass, to thereby obtain [Pigment/Wax Dispersion Liquid 1].

[Pigment/Wax Dispersion Liquid 1] (976 parts) was mixed with a TK homomixer (manufactured by Tokushu-Kika Kogyo Co., Ltd.) at 5,000 rpm for 1 minute. After this, [Isocyanate-Modified Polyester 1] (88 parts) was added thereto, and they were mixed with a TK homomixer (manufactured by Tokushu-Kika Kogyo Co., Ltd. at 5,000 rpm for 1 minute, to thereby obtain [Oil Phase 1]. A solid content of the obtained [Oil Phase 1] was measured, and it was 52.0% by mass. The amount of ethyl acetate relative to the solid content was 92% by mass.

### <Aqueous Phase Producing Step>

Ion-exchanged water (970 parts), a 25% by mass aqueous dispersion liquid of organic resin particles for dispersion stability (a copolymer of styrene/methacrylic acid/butyl acrylate/methacrylic acid ethylene oxide adduct sulfate sodium salt) (40 parts), a 48.5% by mass aqueous solution of sodium dodecyl diphenyl ether disulfonate (95 parts), and ethyl acetate (98 parts) were mixed and stirred, resulting in a pH of 6.2. To which, a 10% by mass sodium hydroxide aqueous solution was dropped, for pH adjustment to 9.5, to thereby obtain [Aqueous Phase 1].

### <Toner Producing Step>

The obtained [Aqueous Phase 1] (1,200 parts) was added to the obtained [Oil Phase 1], and they were mixed with a TK homomixer at a rotation speed adjusted within a range of from 8,000 rpm to 15,000 rpm for 2 minutes, while being cooled in a water bath to be adjusted to a liquid internal temperature of from 20° C. to 23° C. in order to suppress temperature rising due to shear heat of the mixer. After this, they were stirred with a three-one motor mounted with an anchor blade at a rotation speed adjusted within a range of from 130 rpm to 350 rpm for 10 minutes, to thereby obtain [Core Particle Slurry 1] in which liquid droplets of the oil phase that were to become the core particles were dispersed in the aqueous phase.

### <Desolventizing Step>

[Core Particle Slurry 1] was added in a vessel equipped with a stirrer and a thermometer, and desolventized at 30° C. for 8 hours while being stirred, to thereby obtain [Dispersion Slurry 1]. A small amount of [Dispersion Slurry 1] was put over a slide glass and covered with a cover glass, and the condition thereof was observed with an optical microscope at a magnification of ×200. As a result, uniform colored particles were observed.

### <Washing/Drying Step>

After [Dispersion Slurry 1] (100 parts) was filtered at reduced pressure, the operations (1) to (4) below were performed.

(1): Ion-exchanged water (100 parts) was added to a resulting filtration cake, and they were mixed with a TK homomixer (at a rotation speed of 12,000 rpm for 10 minutes), and then filtered.

(2): Ion-exchanged water (900 parts) was added to the filtration cake of (1), and they were mixed with a TK homomixer (at a rotation speed of 12,000 rpm for 30 minutes) with application of ultrasonic vibrations, and then filtered at reduced pressure. This operation was repeated until the electric conductivity of the reslurry liquid became 10 μC/cm or less.

(3): 10% hydrochloric acid was added to the reslurry liquid of (2) to be at a pH of 4, and the resultant was stirred with a three-one motor for 30 minutes, and then filtered.

(4): Ion-exchanged water (100 parts by mass) was added to the filtration cake of (3), and they were mixed with a TK homomixer (at a rotation speed of 12,000 rpm for 10 minutes), and then filtered. This operation was repeated until the electric conductivity of the reslurry liquid became 10 μC/cm or less, to thereby obtain [Filtration Cake 1]. [Filtration Cake 1] was dried with a circulating air dryer at 45° C. for 48 hours, and sieved through a mesh with a mesh size of 75 μm, to thereby obtain [Toner 1]. It was confirmed that the organic resin particles (a copolymer of styrene/methacrylic acid/butyl acrylate/methacrylic acid ethylene oxide adduct sulfate sodium salt) were kept remaining in the surface of the toner 1 (by measurement and observation by nuclear magnetic resonance).

### Example 2

[Toner 2] was obtained in the same manner as in Example 1, except that the binder resin 1 (545 parts) used in <Oil Phase Producing Step> of Example 1 was changed to the binder resin 2 (545 parts). Organic resin particles similar to those of the toner 1 were kept remaining in the surface of the toner 2 (measurement and observation by nuclear magnetic resonance).

### Example 3

[Toner 3] was obtained in the same manner as in Example 1, except that the binder resin 1 (545 parts) used in <Oil Phase Producing Step> of Example 1 was changed to the binder resin 3 (545 parts). Organic resin particles similar to those of the toner 1 were kept remaining in the surface of the toner 3 (measurement and observation by nuclear magnetic resonance).

### Example 4

[Toner 4] was obtained in the same manner as in Example 1, except that the binder resin 1 (545 parts) used in <Oil Phase Producing Step> of Example 1 was changed to the binder resin 4 (545 parts). Organic resin particles similar to those of the toner 1 were kept remaining in the surface of the toner 4 (measurement and observation by nuclear magnetic resonance).

### Example 5

[Toner 5] was obtained in the same manner as in Example 1, except that the binder resin 1 (545 parts) used in <Oil Phase Producing Step> of Example 1 was changed to the binder resin 5 (545 parts). Organic resin particles similar to those of the toner 1 were kept remaining in the surface of the toner 5 (measurement and observation by nuclear magnetic resonance).

### Example 6

[Toner 6] was obtained in the same manner as in Example 1, except that the binder resin 1 (545 parts) used in <Oil Phase Producing Step> of Example 1 was changed to the binder resin 6 (545 parts). Organic resin particles similar to those of the toner 1 were kept remaining in the surface of the toner 6 (measurement and observation by nuclear magnetic resonance).

### Example 7

[Toner 7] was obtained in the same manner as in Example 1, except that the binder resin 1 (545 parts) used in <Oil Phase Producing Step> of Example 1 was changed to the binder resin 7 (545 parts). Organic resin particles similar to those of the toner 1 were kept remaining in the surface of the toner 7 (measurement and observation by nuclear magnetic resonance).

### Example 8

[Toner 8] was obtained in the same manner as in Example 1, except that the binder resin 1 (545 parts) used in <Oil Phase Producing Step> of Example 1 was changed to the binder resin 8 (545 parts). Organic resin particles similar to those of the toner 1 were kept remaining in the surface of the toner 8 (measurement and observation by nuclear magnetic resonance).

### Example 9

[Toner 9] was obtained in the same manner as in Example 1, except that the binder resin 1 (545 parts) used in <Oil Phase Producing Step> of Example 1 was changed to the binder resin 9 (545 parts). Organic resin particles similar to those of the toner 1 were kept remaining in the surface of the toner 9 (measurement and observation by nuclear magnetic resonance).

### Example 10

[Toner 10] was obtained in the same manner as in Example 9, except that the organic resin particles for dispersion stability (a copolymer of styrene/methacrylic acid/butyl acrylate/methacrylic acid ethylene oxide adduct sulfate sodium salt) used in <Aqueous Phase Producing Step> of Example 9 was changed to polyester particles made of bisphenol and isophthalic acid. The polyester particles were kept remaining in the surface of the toner 10 (measurement and observation by nuclear magnetic resonance).

### Comparative Example 1

[Toner 11] was obtained in the same manner as in Example 1, except that the binder resin 1 (545 parts) used in <Oil Phase Producing Step> of Example 1 was changed to the binder resin 10 (545 parts). Organic resin particles similar to those of the toner 1 were kept remaining in the surface of the toner 11 (measurement and observation by nuclear magnetic resonance).

### Comparative Example 2

[Toner 12] was obtained in the same manner as in Example 1, except that the binder resin 1 (545 parts) used in <Oil Phase Producing Step> of Example 1 was changed to the binder resin 11 (545 parts). Organic resin particles similar to those of the toner 1 were kept remaining in the surface of the toner 12 (measurement and observation by nuclear magnetic resonance).

Next, evaluations were performed with each of the obtained [Toner 1] to [Toner 12].

### [Production of Carrier]

A silicone resin (organo straight silicone) (100 parts), γ-(2-aminoethyl)aminopropyl trimethoxy silane (5 parts), and carbon black (10 parts) were added in toluene (100 parts), and they were dispersed with a homomixer for 20 minutes, to thereby prepare a resin layer coating liquid. With a fluid bed coating machine, the resin layer coating liquid was applied to the surface of spherical magnetite (1,000 parts) having a volume average particle diameter of 50 μm, to thereby produce [Carrier 1].

### [Production of Developer]

Each of [Toner 1] to [Toner 12] (5 parts), and [Carrier 1] (95 parts) were mixed, to thereby produce two-component developers [Toner 1] to [Toner 12].

### <Evaluations>

Next, with [Toner 1] to [Toner 12], and the two-component developers produced as above, spreadability, low temperature fixability, and heat resistant storage stability (heat resistant preservation stability) were evaluated according to the evaluation methods and evaluation criteria described below. The results are shown in Table 1 below.

### [Evaluation Method]

### <Spreadability>

A flow tester (CFT-500 manufactured by Shimadzu Corporation) was used. A measurement sample (toner) was weighed out in an amount of 1.5 g, and measured with a die having a diameter φ of 1.0 mm and a height H of 1.0 mm, under temperature conditions of a temperature raising rate of 3.0° C./min, a preheating time of 180 seconds, and a measurement temperature range of from 80° C. to 140° C., and under each of two load conditions of 5 kg and 2 kg, to thereby measure flowing start is temperatures Tfb(5 kg) and Tfb(2 kg) of the toner. Using the obtained flowing start temperatures Tfb(5 kg) and Tfb (2 kg), Tfb(2-5) was calculated according to Formula 1 below.

Tfb(2-5)=100-[Tfb(5 Kg)/Tfb(2 Kg)]×100 (Formula 1)

A lower value of Tfb(2-5) indicates a higher self-spreadability, which means that even when the pressure is close to zero, toner particles spread (stretch) with their own weight at around a temperature at which the toner melts. A greater spreading of the toner means a greater degree of low temperature fixability of the toner.

Here, Tfb(2-5) is preferably in the range represented by Formula (2) below.

2.00≦Tfb(2-5)≦6.50 (Formula 2)

It is not preferable that Tfb(2-5) be less than 2.00, because storage stability is extremely poor. It is also not preferable that Tfb(2-5) be greater than 6.50, because the toner may be partially fixed in failure.

Tfb(2-5) is more preferably from 2.50 to 3.20.

### <Low Temperature Fixability>

A copier MF2200 (manufactured by Ricoh Co., Ltd.) using a Teflon® roller as a fixing roller was remodeled in the fixing unit, and used to perform a test of copying a solid image on sheets TYPE 6200 (manufactured by Ricoh Co., Ltd.) with a toner deposition amount of 0.8 mg/cm².

Specifically, a fixing test was performed by varying the fixing temperature, to find a cold offset temperature (minimum fixing temperature).

As the conditions for evaluating a minimum fixing temperature, a linear velocity for paper feeding was set to a range of from 150 mm/second to 200 mm/second, a surface pressure was set to 1.2 kgf/cm², and a nip width was set to 4 mm.

The minimum fixing temperature was evaluated based on the evaluation criteria below.

### [Evaluation Criteria]

A: Lower than 125° C. (Very good)

B: 125° C. or higher but lower than 130° C. (Good)

C: 130° C. or higher but lower than 140° C. (Normal)

D: 140° C. or higher (Bad)

### <Heat Resistant Storage Stability (Heat Resistant Preservation Stability)>

Each toner was weighed out in an amount of 10 g, and put into a 20 mL glass vessel. The glass bottle was tapped with a tapping machine a hundred times, and then left for 24 hours in a thermostatic bath that was set to a temperature of 50° C. and a humidity of 80%. After this, a penetration degree was measured with a penetrometer (manufactured by Nikka Engineering, Co., Ltd., with conditions described in a manual), and evaluated based on the evaluation criteria below.

### [Evaluation Criteria]

A: The penetration degree was 20 mm or greater (Very good).

B: The penetration degree was 15 mm or greater but less than 20 mm (Good).

C: The penetration degree was 10 mm or greater but less than 15 mm (Normal).

D: The penetration degree was less than 10 mm (Bad).

TABLE 1

| | | | | Heat resistant |
|---|---|---|---|---|
| | | Spread- | Low | storage stability |
| | | ability | temperature | (heat resistant pres- |
| Example | Toner | Tfb(2-5) | fixability | ervation stability) |
| Ex. 1 | Toner 1 | 6.45 | C | A |
| Ex. 2 | Toner 2 | 2.08 | A | C |
| Ex. 3 | Toner 3 | 3.14 | B | B |
| Ex. 4 | Toner 4 | 2.52 | B | B |
| Ex. 5 | Toner 5 | 2.80 | B | B |
| Ex. 6 | Toner 6 | 2.91 | B | B |
| Ex. 7 | Toner 7 | 2.82 | B | B |
| Ex. 8 | Toner 8 | 2.62 | A | A |
| Ex. 9 | Toner 9 | 2.70 | A | A |
| Ex. 10 | Toner 10 | 2.55 | A | A |
| Comp. | Toner 11 | 6.70 | D | A |
| Ex. 1 | | | | |
| Comp. | Toner 12 | 1.88 | A | D |
| Ex. 2 | | | | |

From the valuation results shown in Table 1, all of the toners 1 to 10 of the present invention of which Tfb(2-5) was controlled to the range of from 2.00 to 6.50 had excellent spreadability, and favorable low temperature fixability and heat resistant storage stability. Particularly, the toners 3 to 10 of which Tfb(2-5) was in the range of from 2.50 to 3.20 were good or very good in both of low temperature fixability and heat resistant storage stability.

On the other hand, the toner 11 of which Tfb(2-5) was greater than 6.50 was bad in low temperature fixability, although it was very good in heat resistant storage stability. Further, the toner 12 of which Tfb(2-5) was less than 2.00 was bad in heat resistant storage stability, although it was very good in low temperature fixability.

According to the present invention, it is possible to meet the demand for energy saving, by realizing low temperature fixability of a toner while satisfying both of heat resistant storage stability and hot offset resistance of the toner at the same time. With such a toner, it is possible to satisfy speediness, compactness, colorization, and high image quality that are strongly demanded of image forming apparatuses such as a copier, a laser printer, an ordinary facsimile machine, etc., and image forming methods.

This application claims priority to Japanese application No. 2014-005881, filed on Jan. 16, 2014 and incorporated herein by to reference.

What is claimed is:

1. A static charge image developing toner,
wherein flowing start temperatures (Tfb) of the static charge image developing toner measured with a flow tester satisfy relational formulae below:
Tfb(2-5)=100−[Tfb(5 Kg)/Tfb(2 Kg)]×100 (Formula 1)
2.00≦Tfb(2-5)≦6.50 (Formula 2)
where in Formula 1 above, Tfb(2 Kg) and Tfb(5 Kg) represent flowing start temperatures of the static charge image developing toner when 1.5 g of the static charge image developing toner is heated at a temperature raising rate of 3° C./minute and let to flow out from a die having a diameter of 1.0 mm under loads of 2 Kg and 5 Kg respectively.

2. The static charge image developing toner according to claim 1,
wherein the static charge image developing toner comprises polyester.

3. The static charge image developing toner according to claim 2,
wherein an acid component-derived structural unit constituting a molecular skeleton of the polyester is a structural unit derived from an aromatic dicarboxylic acid compound having a carboxylic acid group at a meth-position or a para-position of a benzene ring thereof.

4. The static charge image developing toner according to claim 1,
wherein the static charge image developing toner comprises isocyanate-modified polyester.

5. The static charge image developing toner according to claim 1,
wherein the static charge image developing toner comprises a styrene-acrylic copolymer

6. The static charge image developing toner according to claim 1,
wherein organic resin particles are present in a surface of the static charge image developing toner.

7. The static charge image developing toner according to claim 1,
wherein the static charge image developing toner is granulated by dispersing an oil phase containing a binder resin in an organic solvent, in an aqueous medium containing organic resin particles as a protective colloid agent, and
wherein the organic resin particles remain in surfaces of granulated particles obtained from the granulation.

8. An image forming apparatus, comprising:
a latent image bearer configured to bear a latent image;
a charging unit configured to electrically charge a surface of the latent image bearer;
an exposure unit configured to expose the electrically charged surface of the latent image bearer to light to write an electrostatic latent image on the electrically charged surface of the latent image bearer;
a developing unit that comprises a toner and is configured to supply the toner to the electrostatic latent image formed on the surface of the latent image bearer, and develop the electrostatic latent image to form a toner image,
a transfer unit configured to transfer the toner image developed on the surface of the latent image bearer onto a receiving member; and
a fixing unit configured to fix the toner image on the receiving member thereon,
wherein the toner is the static charge image developing toner according to claim 1.

9. An image forming method, comprising:
electrically charging a surface of a latent image bearer;
exposing the electrically charged surface of the latent image bearer to light to write an electrostatic latent image on the electrically charged surface of the latent image bearer;
supplying a toner to the electrostatic latent image formed on the surface of the latent image bearer, and developing the electrostatic latent image to form a toner image;
transferring the toner image on the surface of the latent image bearer onto a receiving member; and
fixing the toner image on the receiving member thereon,
wherein the toner is the static charge image developing toner according to claim 1.

10. A process cartridge, comprising as an integrated unit:
a latent image bearer; and
at least a developing unit that comprises a toner and is configured to develop an electrostatic latent image on the latent image bearer with the toner,
wherein the process cartridge is detachably mountable into a body of a image forming apparatus, and
wherein the toner is the static charge image developing toner according to claim 1.
